(19) United States
(12) Patent Application Publication
(10) Pub. No.: US 2013/0055914 A1
(43) Pub. Date: Mar. 7, 2013

(54) RELIEF PRINTING PLATE PRECURSOR FOR LASER ENGRAVING, RELIEF PRINTING PLATE, AND PROCESS FOR MAKING SAME

(71) Applicant: Shigefumi KANCHIKU, Shizuoka (JP)

(72) Inventor: Shigefumi KANCHIKU, Shizuoka (JP)

(73) Assignee: FUJIFILM CORPORATION, Tokyo (JP)

(21) Appl. No.: 13/601,650

(22) Filed: Aug. 31, 2012

(30) Foreign Application Priority Data
Sep. 2, 2011 (JP) 2011-191395

(51) Int. Cl. B32B 27/00; B41N 1/00; B32B 27/30; B32B 27/36; B32B 27/40; B29C 59/16

(52) U.S. Cl. 101/395; 428/339; 428/331; 264/400

(57) ABSTRACT

A relief printing plate precursor comprising, on a support, a relief-forming layer comprising (Component A) an ethylenically unsaturated compound; (Component B) a thermal polymerization initiator; and (Component C) an amine compound represented by any of formulae (I) to (III) below, wherein the relief-forming layer having a thickness of 0.1 mm to 10 mm.

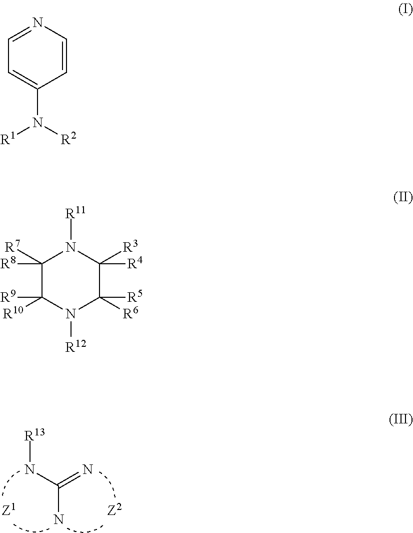

### TECHNICAL FIELD

The present invention relates to a relief printing plate precursor for laser engraving, a relief printing plate, and a process for making same.

### BACKGROUND ART

A large number of so-called “direct engraving CTP methods”, in which a relief-forming layer is directly engraved by means of a laser to make a plate, have been proposed. In this method, a laser light is directly irradiated to a flexographic precursor to cause thermal decomposition and volatilization by photothermal conversion, and thereby, depressions are formed. Unlike the relief formation achieved by using an original image film, the direct engraving CTP method can freely control the relief shape. Accordingly, when images such as outline characters are formed, it is possible to engrave that region deeper than other regions, or to perform shouldered engraving in fine halftone dot images, while taking the resistance to printing pressure into consideration.

Relief printing plate precursors for laser engraving in the related art are known in, for example, JP-A-2011-51273 (JP-A denotes a Japanese unexamined patent application publication).

Furthermore, a curable composition used in planographic printing plates is known in, for example, JP-A-2009-96911.

### DISCLOSURE OF INVENTION

### Problems to be Solved by the Invention

Generally, since a relief printing plate precursor is very thick with a thickness of, for example, 0.1 mm to 10 mm, delamination due to the polymer or the crosslinked polymer is likely to occur, and particularly when a radical polymerization crosslinking agent is included, conspicuous delamination can be observed. When delamination occurs, the strength varies in different layers, and a decrease in strength upon bending, or peeling from the interface is prone to occur. Furthermore, since the composition in the film becomes non-uniform, it is difficult to supply the composition stably during production. Also, since the shrinkage ratio varies in different layers, the different shrinkage ratios cause curling, so that once the printing plate curls, it is difficult to handle the plate at the time of installing the printing plate.

Under such circumstances in the related art, the present invention has been achieved in order to solve the problems described below.

That is, an object of the present invention is to provide a relief printing plate precursor which can suppress curling and delamination in the relief-forming layer, a relief printing plate using the relief printing plate precursor, and a process for making the relief printing plate.

### Means for Solving the Problems

The problems of the present invention described above were solved by the means described in the following <1> and <11> to <13>. Preferred exemplary embodiments <2> to <10> and <14> will be described together below.

<1> A relief printing plate precursor, having, on a support, a relief-forming layer including (Component A) an ethylenically unsaturated compound, (Component B) a thermal polymerization initiator, and (Component C) an amine compound represented by any one of the following formulae (I) to (III):

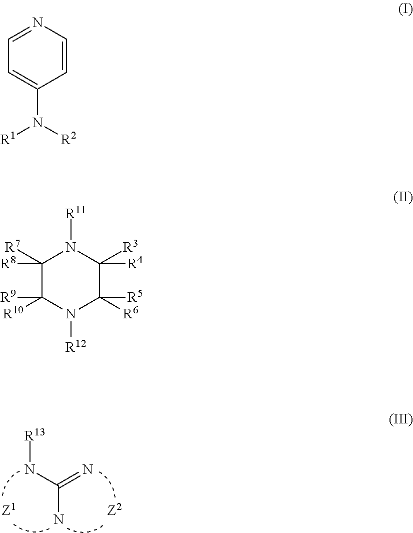

(In the formula (I), R¹ and R² independently represent a hydrogen atom, an alkyl group, a cycloalkyl group, an aralkyl group or an aryl group; in the formula (II), R³ to R¹⁰ independently represent a hydrogen atom, an alkyl group, a cycloalkyl group, an aralkyl group or an aryl group, while these groups may have a substituent, or may be linked to each other to form a ring; R¹¹ and R¹² independently represent a hydrogen atom, an alkyl group, a cycloalkyl group, an aralkyl group or an aryl group, while these groups may have a substituent; R³ to R¹⁰ and R¹¹ or R¹² may be linked to each other to form a ring; in the formula (III), R¹³ represents a hydrogen atom, an alkyl group, a cycloalkyl group, an aralkyl group, an aryl group or an acyl group, while these groups may have a substituent; and Z¹ and Z² independently represent an atomic group which forms a monocyclic or polycyclic ring structure together with an amino group, provided that Z¹ and Z² may be linked to each other to form a ring.), wherein the relief-forming layer having a thickness of 0.1 mm to 10 mm.

<2> The relief printing plate precursor as described in <1>, wherein the content of Component C in the relief-forming layer is 1 wt % to 100 wt %, relative to 100 wt % of the content of Component A in the relief-forming layer.

<3> The relief printing plate precursor as described in <1> or <2>, wherein Component B is an organic peroxide.

<4> The relief printing plate precursor as described in any one of <1> to <3>, wherein the relief-forming layer further contains (Component D) a binder polymer.

<5> The relief printing plate precursor for laser engraving as described in <4>, wherein Component D is one or more resins selected from the group consisting of a polycarbonate resin, a polyurethane resin, an acrylic resin, a polyester resin and a vinyl resin.

<6> The relief printing plate precursor as described in any one of <1> to <5>, wherein the relief-forming layer further contains (Component E) silica particles;

<7> The relief printing plate precursor as described in <6>, wherein the number average particle size of Component E is 0.01 μm to 10 μm.

<8> The relief printing plate precursor as described in any one of <1> to <7>, wherein the relief-forming layer further comprises (Component F) a photothermal conversion agent capable of absorbing light having a wavelength of 700 to 1,300 nm.

<9> A relief printing plate precursor having a crosslinked relief-forming layer obtained by thermally crosslinking the relief-forming layer in the relief printing plate precursor for laser engraving as described in any one of <1> to <8>.

<10> The relief printing plate precursor as described in <9>, wherein the Shore A hardness of the crosslinked relief-forming layer is 50° to 90°.

<11> A process for making a relief printing plate, the method including (1) thermally crosslinking the relief-forming layer in the relief printing plate precursor as described in any one of <1> to <8>; and (2) laser-engraving the crosslinked relief-forming layer and thereby forming a relief layer.

<12> A process for making a relief printing plate, the method including (1′) preparing the relief printing plate precursor for laser engraving having a crosslinked relief-forming layer as described in <8> or <9>; and (2′) laser-engraving the crosslinked relief-forming layer and thereby forming a relief layer.

<13> A relief printing plate having a relief layer produced by the process for making the plate as described in <11> or <12>.

<14> The relief printing plate as described in <13>, wherein the Shore A hardness of the relief layer is 50° to 90°.

### MODE FOR CARRYING OUT THE INVENTION

Hereinafter, the present invention will be described in detail.

Meanwhile, according to the present invention, the indication of “lower limit to upper limit” representing a numerical value range means “greater than or equal to the lower limit and less than or equal to the upper limit”, and the indication of “upper limit to lower limit” means “equal to or less than the upper limit and equal to or greater than the lower limit”. That is, the indication represents a numerical value range including the upper limit and the lower limit. Furthermore, according to the present invention, “(Component A) an ethylenically unsaturated compound having a weight average molecular weight of less than 5,000” or the like may be simply described as “Component A”.

### (Relief Printing Plate Precursor for Laser Engraving)

The relief printing plate precursor for laser engraving (hereinafter, may also be simply referred to as “relief printing plate precursor”) of the present invention has, on a support, a relief-forming layer including (Component A) an ethylenically unsaturated compound, (Component B) a thermal polymerization initiator, and (Component C) an amine compound represented by any of formulae (I) to (III) below.

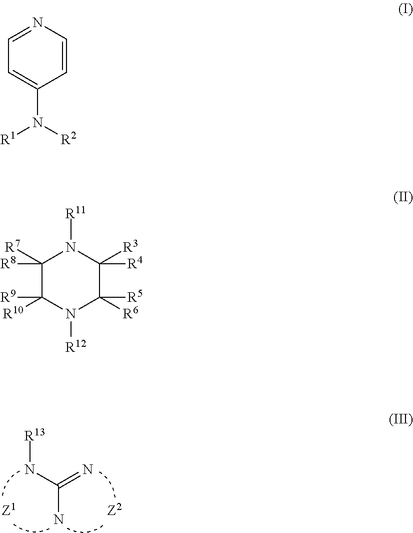

(In the formula (I), R¹ and R² independently represent a hydrogen atom, an alkyl group, a cycloalkyl group, an aralkyl group or an aryl group; in the formula (II), R³ to R¹⁰ independently represent a hydrogen atom, an alkyl group, a cycloalkyl group, an aralkyl group or an aryl group, while these groups may have a substituent, or may be linked to each other to form a ring; R¹¹ and R¹² independently represent a hydrogen atom, an alkyl group, a cycloalkyl group, an aralkyl group, or an aryl group, while these groups may have a substituent; R³ to R¹⁰ and R¹¹ or R¹² may be linked to each other to form a ring; in the formula (III), R¹³ represents a hydrogen atom, an alkyl group, a cycloalkyl group, an aralkyl group, an aryl group or an acyl group, while these groups may have a substituent; and Z¹ and Z² independently represent an atomic group that forms a monocyclic or polycyclic ring structure together with an amino group, provided that Z¹ and Z² may also be linked to each other to form a ring.)

In regard to relief printing plate precursors for laser engraving in the related art, the inventors of the present invention found by visual inspection that in the films having the thickness of 1 mm, a layer which has about 0.3 mm to 0.4 mm thick is present on the side of the surface that is in contact with air, and the layer is occasionally observed to cause delamination. Usually, it is contemplated that in a light-induced radical polymerization system, the effect of oxygen is exhibited in a region of several micrometers to several tens of micrometers deep from the outermost layer, while in a heat-induced radical polymerization system where the reaction rate is relatively mild, the effect of oxygen on polymerization inhibition is small.

The inventors of the present invention conducted thorough investigations, and as a result, the inventors came to suspect that the layer observed on the side of the surface that is in contact with air is softer than the interior of the film, and polymerization has not sufficiently proceeded. In a thermal polymerization system such as in the present invention, it can be contemplated that since the time required for crosslinking is long, the effect of oxygen on polymerization inhibition may be large in contradiction to the findings in the related art, and delamination may occur due to the difference in the extent of progress of polymerization.

It is speculated that in the relief printing plate precursor for laser engraving of the present invention, although the mechanism is not clearly understood, when an amine compound represented by any one of formulae (I) to (III) (hereinafter, may also be called “specific amine compound”) is used in the relief-forming layer, inhibition of radical polymerization by oxygen is prevented, and the problem of delamination is solved. Furthermore, also for the problem of curling, it is speculated that when the specific amine compound is used, uniformity of the relief-forming layer is enhanced, and the problem of curling is improved.

Furthermore, although the mechanism is not clearly understood, when the relief printing plate precursor for laser engraving of the present invention has a relief-forming layer including (Component A) an ethylenically unsaturated compound, (Component B) a thermal polymerization initiator, and (Component C) a specific amine compound, the relief printing plate precursor for laser engraving has high engraving sensitivity, has decreased stickiness (tackiness) of the printing plate, and has excellent print durability and rinsing properties.

A relief printing plate precursor for laser engraving of the present invention may comprise a crosslinked relief-forming layer formed by crosslinking the relief-forming layer.

In the present invention, the ‘relief printing plate precursor for laser engraving’ means both or one of a plate having a crosslinkable relief-forming layer formed from the resin composition for laser engraving in a state before being crosslinked and a plate in a state in which it is cured by light and/or heat.

In the present invention, the ‘relief-forming layer’ means a layer in a state before being crosslinked, that is, a layer formed from the resin composition for laser engraving of the present invention, which may be dried as necessary.

In the present invention, the ‘crosslinked relief-forming layer’ means a layer formed by crosslinking the relief-forming layer. The crosslinking is preferably carried out by means of heat and/or light. Furthermore, the crosslinking is not particularly limited as long as it is a reaction by which the resin composition is cured, and it is a concept that includes a structure crosslinked due to reactions between Component B's, but it is preferable to form a crosslinked structure by a reaction between Component B and other Component.

The ‘relief printing plate’ is prepared by laser engraving a printing plate precursor having a crosslinked relief-forming layer.

Moreover, in the present invention, the ‘relief layer’ means a layer of the relief printing plate formed by engraving using a laser, that is, the crosslinked relief-forming layer after laser engraving.

A relief printing plate precursor for laser engraving of the present invention may further comprise, as necessary, an adhesive layer between the support and the (crosslinked) relief-forming layer and, above the (crosslinked) relief-forming layer, a slip coat layer and a protection film.

A relief printing plate precursor for laser engraving of the present invention may preferably be used as a flexography printing plate precursor for laser engraving of the present invention.

A relief printing plate precursor for laser engraving of the present invention has a relief-forming layer on a support.

A material used for the support of the relief printing plate precursor for laser engraving is not particularly limited, but one having high dimensional stability is preferably used, and examples thereof include metals such as steel, stainless steel, or aluminum, plastic resins such as a polyester (e.g. PET (polyethylene terephthalate), PBT (polybutylene terephthalate), or PAN (polyacrylonitrile)) or polyvinyl chloride, synthetic rubbers such as styrene-butadiene rubber, and glass fiber-reinforced plastic resins (epoxy resin, phenolic resin, etc.). Among them, a transparency support is preferable, and a PET film is more preferable.

### <Relief-Forming Layer>

The relief-forming layer in the relief printing plate precursor for laser engraving of the present invention contains (Component A) an ethylenically unsaturated compound, (Component B) a thermal polymerization initiator, and (Component C) a specific amine compound. Furthermore, the relief-forming layer is a thermally crosslinkable layer.

Hereinafter, a composition including (Component A) an ethylenically unsaturated compound, (Component B) a thermal polymerization initiator, and (Component C) a specific amine compound may also be referred to as “composition for laser engraving of the present invention”, or simply as “composition of the present invention”.

The thickness of the relief-forming layer in the relief printing plate precursor for laser engraving of the present invention is preferably 0.1 mm to 10 mm, more preferably 0.2 mm to 7 mm, yet more preferably 0.5 mm to 3 mm, and particularly preferably 0.8 mm to 1.5 mm. When the thickness is in the range described above, the effects of suppressing curling and delamination can be more efficiently exhibited.

Furthermore, the thickness of the crosslinked relief-forming layer in the relief printing plate precursor for laser engraving of the present invention is, similarly to the relief-forming layer, preferably 0.1 mm to 10 mm, more preferably 0.2 mm to 7 mm, yet more preferably 0.5 mm to 3 mm, and particularly preferably 0.8 mm to 1.5 mm.

### (Component A) Ethylenically Unsaturated Compound

The relief-forming layer in the relief printing plate precursor for laser engraving of the present invention contains (Component A) an ethylenically unsaturated compound (also called a “monomer”).

The ethylenically unsaturated compound may arbitrarily be selected from compounds having at least one ethylenically unsaturated group. The ethylenically unsaturated compound may be used only one type or may be used two or more types in combination.

These compound groups are widely known in the present industrial field, and, in the present invention, these may be used without particular limitation. These have chemical forms such as a monomer, a prepolymer, that is, a dimer, a trimer and an oligomer, or copolymers of monomers, and mixtures thereof.

Component A is preferably a two or more functional ethylenically unsaturated compound (a polyfunctional ethylenically unsaturated compound).

Hereinafter, monofunctional monomers having one ethylenically unsaturated group, and polyfunctional monomers having two or more ethylenically unsaturated groups are explained.

In the resin composition of the present invention, polyfunctional monomers are preferably used in order to form a crosslinked structure in the film.

The ethylenically unsaturated compound has preferably a molecular weight of 150 to 5,000, more preferably 200 to 3,500, and yet more preferably 250 to 2,000.

Examples of the monofunctional monomers include esters of an unsaturated carboxylic acid (such as acrylic acid, methacrylic acid, itaconic acid, crotonic acid, isocrotonic acid or maleic acid) with a monovalent alcohol compound, amides of an unsaturated carboxylic acid with a monovalent amine compound, etc. Examples of the polyfunctional monomers include esters of an unsaturated carboxylic acid (such as acrylic acid, methacrylic acid, itaconic acid, crotonic acid, isocrotonic acid or maleic acid) with a polyvalent alcohol compound, amides of an unsaturated carboxylic acid with a polyvalent amine compound, etc.

Further, addition products of an unsaturated carboxylic acid ester or amide having a nucleophilic substituent such as a hydroxy group, an amino group or a mercapto group with a monofunctional or polyfunctional isocyanate or epoxy, dehydrating condensation products with a monofunctional or polyfunctional carboxylic acid, etc. are used preferably.

Moreover, addition reaction products of unsaturated carboxylic acid esters or amides having an electrophilic substituent such as an isocyanato group or an epoxy group with monofunctional or polyfunctional alcohols, amines, or thiols, and substitution reaction products of unsaturated carboxylic acid esters or amides having a leaving group such as a halogen group or a tosyloxy group with monofunctional or polyfunctional alcohols, amines, or thiols are also used preferably.

Among them, the monofunctional monomer is preferably an oligomer having an ethylenically unsaturated group, and is particularly preferably methoxypolyethyleneglycol methacrylate.

As the polyfunctional ethylenically unsaturated compound, a compound having 2 to 20 terminal ethylenically unsaturated groups is preferable.

Examples of compounds from which the ethylenically unsaturated group in the polyfunctional monomer is derived include unsaturated carboxylic acids (such as acrylic acid, methacrylic acid, itaconic acid, crotonic acid, isocrotonic acid and maleic acid), and esters and amides thereof. Preferably esters of an unsaturated carboxylic acid and an aliphatic polyhydric alcoholic compound, or amides of an unsaturated carboxylic acid and an aliphatic polyvalent amine compound are used. Moreover, addition reaction products of unsaturated carboxylic acid esters or amides having a nucleophilic substituent such as a hydroxyl group or an amino group with polyfunctional isocyanates or epoxies, and dehydrating condensation reaction products with a polyfunctional carboxylic acid, etc. are also used favorably. Moreover, addition reaction products of unsaturated carboxylic acid esters or amides having an electrophilic substituent such as an isocyanato group or an epoxy group with monofunctional or polyfunctional alcohols or amines, and substitution reaction products of unsaturated carboxylic acid esters or amides having a leaving group such as a halogen group or a tosyloxy group with monofunctional or polyfunctional alcohols or amines are also favorable. Moreover, as another example, the use of compounds obtained by replacing the unsaturated carboxylic acid with a vinyl compound, an allyl compound, an unsaturated phosphonic acid, styrene or the like is also possible.

The polyfunctional monomer described above is preferably an acrylate compound, a methacrylate compound, a vinyl compound, or an aryl compound, and particularly preferably an acrylate compound or a methacrylate compound, from the viewpoint of reactivity. Furthermore, from the viewpoint of print durability, the polyfunctional monomer more preferably has three or more ethylenically unsaturated groups.

Specific examples of ester monomers comprising an ester of an aliphatic polyhydric alcohol compound and an unsaturated carboxylic acid include acrylic acid esters such as ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl)ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl)isocyanurate, and a polyester acrylate oligomer.

Examples of methacrylic acid esters include tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane, and bis[p-(methacryloxyethoxy)phenyl]dimethylmethane. Among them, trimethylolpropane trimethacrylate is particularly preferable.

As examples of other esters, aliphatic alcohol-based esters described in JP-B-46-27926 (JP-B denotes a Japanese examined patent application publication), JP-B-51-47334 and JP-A-57-196231, those having an aromatic skeleton described in JP-A-59-5240, JP-A-59-5241, and JP-A-2-226149, those having an amino group described in JP-A-1-165613, etc. may also be used preferably.

The above-mentioned ester monomers may be used as a mixture.

Furthermore, specific examples of amide monomers including an amide of an aliphatic polyamine compound and an unsaturated carboxylic acid include N,N′-methylenebisacrylamide, N,N′-methylenebismethacrylamide, 1,6-hexamethylenebisacrylamide, 1,6-hexamethylenebismethacrylamide, diethylenetriaminetrisacrylamide, xylylenebisacrylamide, and xylylenebismethacrylamide.

Preferred examples of other amide-based monomers include those having a cyclohexylene structure described in JP-B-54-21726.

Furthermore, a urethane-based addition-polymerizable compound produced by an addition reaction of an isocyanate and a hydroxy group is also suitable, and specific examples thereof include a vinylurethane compound comprising two or more polymerizable vinyl groups per molecule in which a hydroxy group-containing vinyl monomer represented by Formula (I) below is added to a polyisocyanate compound having two or more isocyanate groups per molecule described in JP-B-48-41708.

CH₂═C(R)COOCH₂CH(R′)OH (i)

wherein R and R′ independently denote H or CH₃.

Furthermore, urethane acrylates described in JP-A-51-37193, JP-B-2-32293, and JP-B-2-16765, and urethane compounds having an ethylene oxide-based skeleton described in JP-B-58-49860, JP-B-56-17654, JP-B-62-39417, JP-B-62-39418 are also suitable.

Furthermore, by use of an addition-polymerizable compound having an amino structure or a sulfide structure in the molecule described in JP-A-63-277653, JP-A-63-260909, and JP-A-1-105238, a photosensitive resin composition having very good photosensitive speed can be obtained.

Other examples include polyester acrylates such as those described in JP-A-48-64183, JP-B-49-43191, and JP-B-52-30490, and polyfunctional acrylates and methacrylates such as epoxy acrylates formed by a reaction of an epoxy resin and (meth)acrylic acid. Examples also include specific unsaturated compounds described in JP-B-46-43946, JP-B-1-40337, and JP-B-1-40336, and vinylphosphonic acid-based compounds described in JP-A-2-25493. In some cases, perfluoroalkyl group-containing structures described in JP-A-61-22048 are suitably used. Moreover, those described as photocuring monomers or oligomers in the Journal of the Adhesion Society of Japan, Vol. 20, No. 7, pp. 300 to 308 (1984) may also be used.

Among these, Component A preferably includes trimethylolpropane trimethacrylate and/or methoxypolyethylene glycol methacrylate, and particularly preferably includes trimethylolpropane trimethacrylate and methoxypolyethylene glycol methacrylate.

The content of Component A contained in the relief-forming layer is preferably 1 wt % to 90 wt %, more preferably 10 wt % to 80 wt %, yet more preferably 20 wt % to 75 wt %, and particularly preferably 30 wt % to 70 wt %. When the content is in the range described above, the relief-forming layer formed from the composition for laser engraving has excellent print durability.

### (Component B) Thermopolymerization Initiator

The relief-forming layer in the relief printing plate precursor for laser engraving of the present invention includes (Component B) a thermopolymerization initiator.

The thermopolymerization initiator is preferably a radical thermopolymerization initiator.

More preferred examples of the radical thermopolymerization initiator include (c) an organic peroxide and (I) an azo-based compound. Compounds as shown below are particularly preferable.

### (c) Organic Peroxides

Preferable (c) organic peroxides as the radical polymerization initiator which can be used in the present invention is preferably ether peroxide such as 3,3,4′,4′-tetra(t-butylperoxycarbonyl)benzophenone, 3,3,4′,4′-tetra(t-amylperoxycarbonyl)benzophenone, 3,3,4′,4′-tetra(t-hexylperoxycarbonyl)benzophenone, 3,3,4′,4′-tetra(t-octylperoxycarbonyl)benzophenone, 3,3,4′,4′-tetra(cumylperoxycarbonyl)benzophenone, 3,3,4′,4′-tetra(p-isopropylcumylperoxycarbonyl)benzophenone, di-t-butyldiperoxy isophthalate etc.

### (I) Azo-Based Compound

Preferable (I) azo-based compounds used as the radical polymerization initiator in the present invention include 2,2′-azobisisobutyronitrile, 2,2′-azobispropionitrile, 1,1′-azobis(cyclohexane-1-carbonitrile), 2,2′-azobis(2-methylbutyronitrile), 2,2′-azobis(2,4-dimethylvaleronitrile), 2,2′-azobis(4-methoxy-2,4-dimethylvaleronitrile), 4,4′-azobis(4-cyanovaleric acid), 2,2′-dimethyl azobisisobutyrate, 2,2′-azobis(2-methylpropionamidoxime), 2,2′-azobis[2-(2-imidazoline-2-yl)propane], 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N-butyl-2-methylpropionamide), 2,2′-azobis(N-cyclohexyl-2-methylpropionamide), 2,2′-azobis[N-(2-propenyl)-2-methylpropionamide], and 2,2′-azobis(2,4,4-trimethylpentane), etc.

The thermopolymerization initiator in the present invention may be used singly or in a combination of two or more compounds.

The content of the thermopolymerization initiator in the relief-forming layer is preferably 0.01 to 10 wt % relative to the total weight of the solids content, and more preferably 0.1 to 7 wt %.

### (Component C) Specific Amine Compound

The relief-forming layer in the relief printing plate precursor for laser engraving of the present invention contains (Component C) a compound represented by the formulae (I) to (III) (specific amine compound). When the relief-forming layer contains Component C, curling and surface stickiness are suppressed, and the relief-forming layer has excellent print durability, rinsing properties and engraving sensitivity.

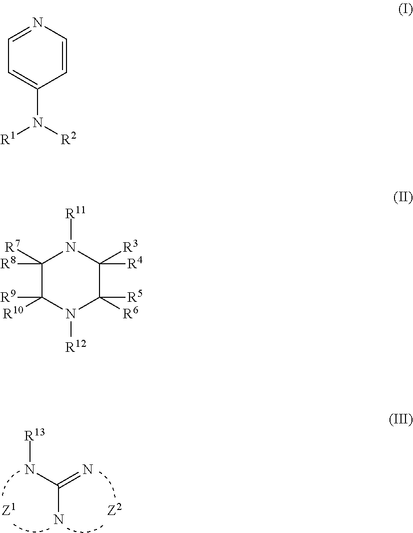

(In the formula (I), R¹ and R² independently represent a hydrogen atom, an alkyl group, a cycloalkyl group, an aralkyl group or an aryl group; in the formula (II), R³ to R¹⁰ independently represent a hydrogen atom, an alkyl group, a cycloalkyl group, an aralkyl group or an aryl group, while these groups may have a substituent, or may be linked to each other to form a ring; R¹¹ and R¹² independently represent a hydrogen atom, an alkyl group, a cycloalkyl group, an aralkyl group or an aryl group, while these groups may have a substituent; R³ to R¹⁰ and R¹¹ or R¹² may be linked to each other to form a ring; in the formula (III), R¹³ represents a hydrogen atom, an alkyl group, a cycloalkyl group, an aralkyl group, an aryl group or an acyl group, while these groups may have a substituent; and Z¹ and Z² independently represent an atomic group which forms a monocyclic or polycyclic ring structure together with an amino group, provided that Z¹ and Z² may be linked to each other to form a ring.)

In the formula (I), R¹ and R² independently represent a hydrogen atom, an alkyl group, a cycloalkyl group, an aralkyl group or an aryl group.

When R¹ and R² each represent an alkyl group, the alkyl group may have a linear structure or may have a branched structure. For example, an alkyl group having 1 to 20 carbon atoms can be used. The number of carbon atoms is preferably 1 to 10, and more preferably 1 to 6, and specific preferred examples include a methyl group, an ethyl group, an isopropyl group, and a butyl group.

When R¹ and R² each represent a cycloalkyl group, as the cycloalkyl group, for example, cycloalkyl groups having 3 to 20 carbon atoms can be used. Among them, a cycloalkyl group having 3 to 10 carbon atoms is preferred, and a cycloalkyl group having 3 to 6 carbon atoms is more preferred.

When R¹ and R² each represent an aralkyl group, examples of the aralkyl group include aralkyl groups having 7 to 20 carbon atoms. Among them, an aralkyl group having 7 to 8 carbon atoms is preferred.

Furthermore, when R¹ and R² each represent an aryl group, examples of the aryl group include aryl groups having 6 to 20 carbon atoms, and among them, an aryl group having 6 to 8 carbon atoms is preferred.

When R¹ and R² each represent one of the substituents described above other than a hydrogen atom, the substituents may further have substituents. Here, examples of the substituent that can be further introduced to the substituents described above include an alkyl group, a cycloalkyl group, an aralkyl group, an aryl group, an acyl group, a hydroxyl group, an amino group, a halogeno group, a carboxyl group, a carbonyl group, a sulfonyl group and a nitro group.

Among these, specific preferred examples of the substituent for R¹ and R² include a methyl group, an ethyl group, an isopropyl group, a hydroxyl group, and an amino group.

When R¹ and R² each represent an alkyl group, examples of the substituent carried by the alkyl group include a cycloalkyl group, an acyl group, a hydroxyl group, an amino group, a halogeno group, a carboxyl group, a carbonyl group, a sulfonyl group, and a nitro group.

When R¹ and R² each represent a cycloalkyl group, examples of the substituent carried by the cycloalkyl group include an alkyl group, a cycloalkyl group, an aralkyl group, an aryl group, an acyl group, a hydroxyl group, an amino group, a halogeno group, a carboxyl group, a carbonyl group, a sulfonyl group, and a nitro group.

When R¹ and R² each represent an aralkyl group, examples of the substituent carried by the aralkyl group include an alkyl group, a cycloalkyl group, an aralkyl group, an aryl group, an acyl group, a hydroxyl group, an amino group, a halogeno group, a carboxyl group, a carbonyl group, a sulfonyl group, and a nitro group.

When R¹ and R² each represent an aryl group, examples of the substituent carried by the aryl group include an alkyl group, a cycloalkyl group, an aralkyl group, an aryl group, an acyl group, a hydroxyl group, an amino group, a halogeno group, a carboxyl group, and a nitro group.

Furthermore, R¹ and R² may be identical with or different from each other. As R¹ and R², a hydrogen atom or an alkyl group is preferred, a hydrogen atom and an alkyl group having 1 to 6 carbon atoms are preferred, and a hydrogen atom and an alkyl group having 1 to 4 carbon atoms are more preferred.

Among (Component C) the specific amine compounds that are particularly suitably used for the present invention, specific examples of the compound represented by the formula (I) include compounds (I-1) to (I-4) shown below, but the present invention is not intended to be limited to these.

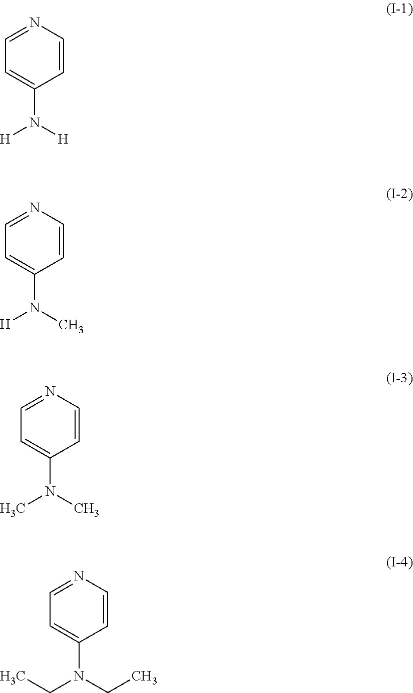

In the formula (II), R³ to R¹⁰ independently represent a hydrogen atom, an alkyl group, a cycloalkyl group, an aralkyl group, or an aryl group, and these groups may have a substituent, or may be linked to each other to form a ring. R¹¹ and R¹² independently represent a hydrogen atom, an alkyl group, a cycloalkyl group, an aralkyl group, or an aryl group, and these groups may have a substituent. Meanwhile, R¹¹ and R¹² are not linked to each other to form a ring. Furthermore, R³ to R¹⁰ and R¹¹ or R¹² may be linked to each other to form a ring.

When R³ to R¹⁰, R¹¹ and R¹² each represent an alkyl group, the alkyl group may have a linear structure or may have a branched structure. For example, the alkyl group may be an alkyl group having 1 to 20 carbon atoms. The number of carbon atoms is preferably 1 to 10, more preferably 1 to 6, and yet more preferably 1 to 4, and specific preferred examples include a methyl group, an ethyl group, and an isopropyl group.

When R³ to R¹⁰, R¹¹ and R¹² each represent a cycloalkyl group, for example, the cycloalkyl group may be a cycloalkyl group having 3 to 20 carbon atoms. The number of carbon atoms is preferably 3 to 10, and more preferably 3 to 6.

When R³ to R¹⁰, R¹¹ and R¹² each represent an aralkyl group, for example, the aralkyl group may be an aralkyl group having 7 to 20 carbon atoms, and the aralkyl group is preferably an aralkyl group having 7 to 12 carbon atoms, and more preferably an aralkyl group having 7 to 8 carbon atoms.

When R³ to R¹⁰, R¹¹ and R¹² each represent an aryl group, the aryl group may be, for example, an aryl group having 6 to 20 carbon atoms, and the aryl group is preferably an aryl group having 6 to 8 carbon atoms.

When R³ to R¹⁰, R¹¹ and R¹² each represent one of the substituents described above other than a hydrogen atom, the substituent may further have a substituent. Here, examples of the substituent that can be further introduced to the substituents include an alkyl group, a cycloalkyl group, an aralkyl group, an aryl group, an acyl group, a hydroxyl group, an amino group, a halogen atom, a carboxyl group, a carbonyl group, a sulfonyl group, and a nitro group. Examples of the substituent employed when R³ to R¹⁰, R¹¹ and R¹² each represent an alkyl group, a cycloalkyl group, an aralkyl group or an aryl group, include the substituents listed as examples in the case where R¹ and R² in the formula (I) each represent an alkyl group, a cycloalkyl group, an aralkyl group or an aryl group.

When any two selected from the group consisting of R³ to R¹⁰ are linked to each other to form a ring, and when one selected from the group consisting of R³ to R¹⁰ and R¹¹ or R¹² form a ring, the ring thus formed is an alkylene group having a monocyclic or polycyclic ring structure, and having a number of carbon atoms that constitute the ring of preferably 1 to 10, and more preferably 1 to 4, excluding the carbon atoms that constitute the piperazine ring of formula (II).

Furthermore, the ring structure may be constituted to include a heteroatom such as N, O or S.

The ring structure may further have a substituent, and may be condensed with another ring.

Examples of the substituent that can be introduced into the ring structure include an alkyl group, a cycloalkyl group, an aralkyl group, an aryl group, an acyl group, a hydroxyl group, an amino group, a halogen atom, a carboxyl group, a carbonyl group, a sulfonyl group, and a nitro group.

R³ to R¹⁰ are each preferably a hydrogen atom, an alkyl group or an aryl group; more preferably a hydrogen atom, an alkyl group having 1 to 6 carbon atoms, or an aryl group having 6 to 10 carbon atoms; and yet more preferably a hydrogen atom, an alkyl group having 1 to 4 carbon atoms, or an aryl group having 6 to 8 carbon atoms.

Furthermore, R¹¹ and R¹² are each preferably a hydrogen atom, an alkyl group or a cycloalkyl group; and more preferably a hydrogen atom, an alkyl group having 1 to 4 carbon atoms, or a cycloalkyl group having 4 to 7 carbon atoms.

Among (Component C) the specific amine compounds suitably used in the present invention, specific examples of the compound represented by formula (II) include compounds (II-1) to (II-16) shown below, but the present invention is not intended to be limited to these.

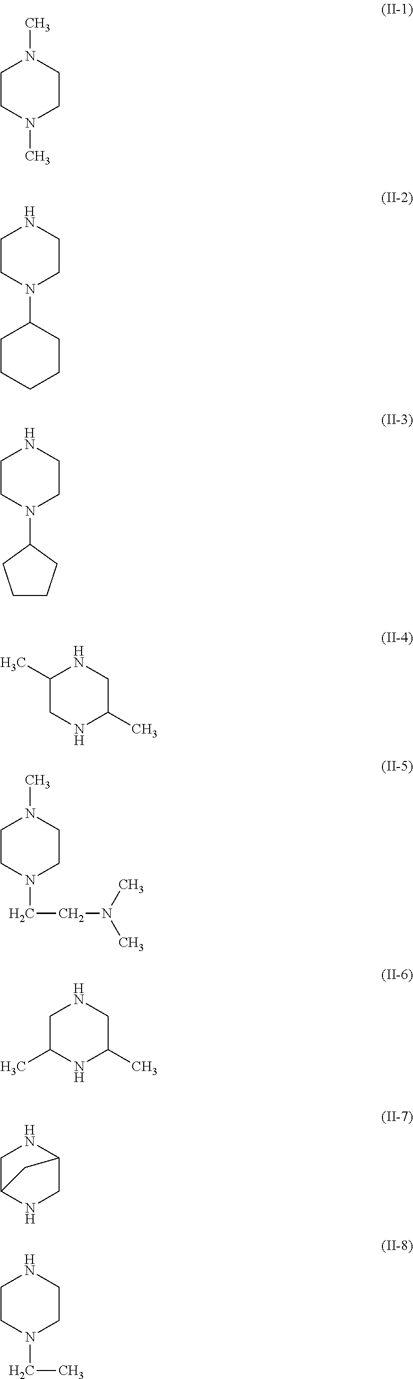

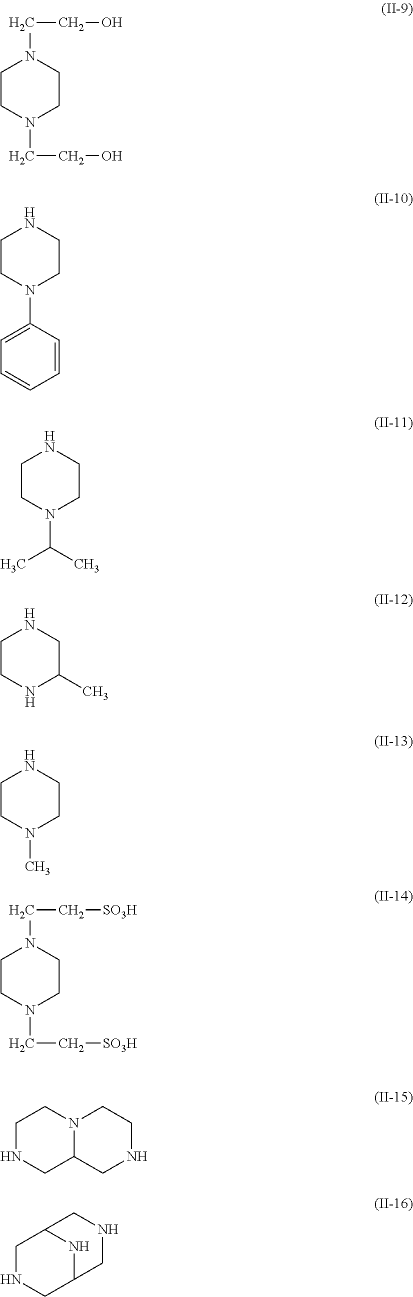

In the formula (III), R¹³ represents a hydrogen atom, an alkyl group, a cycloalkyl group, an aralkyl group, an aryl group, or an acyl group, and these groups may have a substituent. Z¹ and Z² independently represent an atomic group that forms a monocyclic or polycyclic ring structure together with an amino group. Here, Z¹ and Z² may be linked to each other to form a ring.

When R¹³ represents an alkyl group, the alkyl group may have a linear structure, or may have a branched structure. For example, an alkyl group having 1 to 20 carbon atoms can be used. The number of carbon atoms is preferably 1 to 10, and more preferably 1 to 6, and specific preferred examples include a methyl group, an ethyl group, an isopropyl group, and a butyl group.

When R¹³ represents a cycloalkyl group, for example, a cycloalkyl group having 3 to 20 carbon atoms can be used as the cycloalkyl group. Among them, a cycloalkyl group having 3 to 10 carbon atoms is preferred, and a cycloalkyl group having 3 to 6 carbon atoms is more preferred.

When R¹³ represents an aralkyl group, examples of the aralkyl group include aralkyl groups having 7 to 20 carbon atoms, and among them, an aralkyl group having 7 to 8 carbon atoms is preferred.

Furthermore, when R¹³ represents an aryl group, examples of the aryl group include aryl groups having 6 to 20 carbon atoms, and among them, an aryl group having 6 to 8 carbon atoms is preferred.

When R¹³ represents an acyl group, examples of the acyl group include acyl groups having 1 to 6 carbon atoms, and among them, an acyl group having 1 to 3 carbon atoms is preferred. Preferred examples thereof include a formyl group, an acetyl group, and a propionyl group.

When R¹³ represents one of the substituents described above other than a hydrogen atom, the substituent may further have a substituent. Here, examples of the substituent that can be further introduced into the substituent include an alkyl group, a cycloalkyl group, an aralkyl group, an aryl group, an acyl group, a hydroxyl group, an amino group, a halogeno group, a carboxyl group, a carbonyl group, a sulfonyl group, and a nitro group. Examples of the substituent employed when R¹³ represents an alkyl group, a cycloalkyl group, an aralkyl group or an aryl group, include the substituents listed in the case where R¹ and R² in the formula (I) each represent an alkyl group, a cycloalkyl group, an aralkyl group, or an aryl group.

When R¹³ represents an acyl group, examples of the substituent of the acyl group include an alkyl group, a cycloalkyl group, an aralkyl group, an aryl group, an acyl group, a hydroxyl group, an amino group, a halogeno group, a carboxyl group, a carbonyl group, a sulfonyl group, and a nitro group.

Z¹ and Z² are not particularly limited as long as they each represent an atomic group that forms a monocyclic or polycyclic ring structure together with an amino group. Furthermore, Z¹ and Z² may also be linked to each other to form a ring.

The number of carbon atoms of Z¹ and Z² is preferably 2 to 10; an alkylene group having 2 to 4 carbon atoms is more preferred; and an alkylene group having 2 or 3 carbon atoms is yet more preferred. Furthermore, the ring structure may be constituted to include a heteroatom such as N, S or O.

Z¹ and Z² form a monocyclic or polycyclic ring structure together with an amino group, but the ring structure may further have a substituent, or may be condensed with another ring.

Examples of the substituent that can be introduced into the ring structure include an alkyl group, a cycloalkyl group, an aralkyl group, an aryl group, an acyl group, a hydroxyl group, a halogen atom, a carboxyl group, a carbonyl group, a sulfonyl group, and a nitro group.

R¹³ is preferably a hydrogen atom, an alkyl group, or an acyl group; more preferably a hydrogen atom, an alkyl group having 1 to 6 carbon atoms, or an acyl group having 1 to 3 carbon atoms; and yet more preferably a hydrogen atom or an alkyl group having 1 to 4 carbon atoms.

Among (Component C) the specific amine compounds, specific examples of the compound represented by formula (III) include compounds (III-1) to (III-10) shown below, but the present invention is not intended to be limited to these.

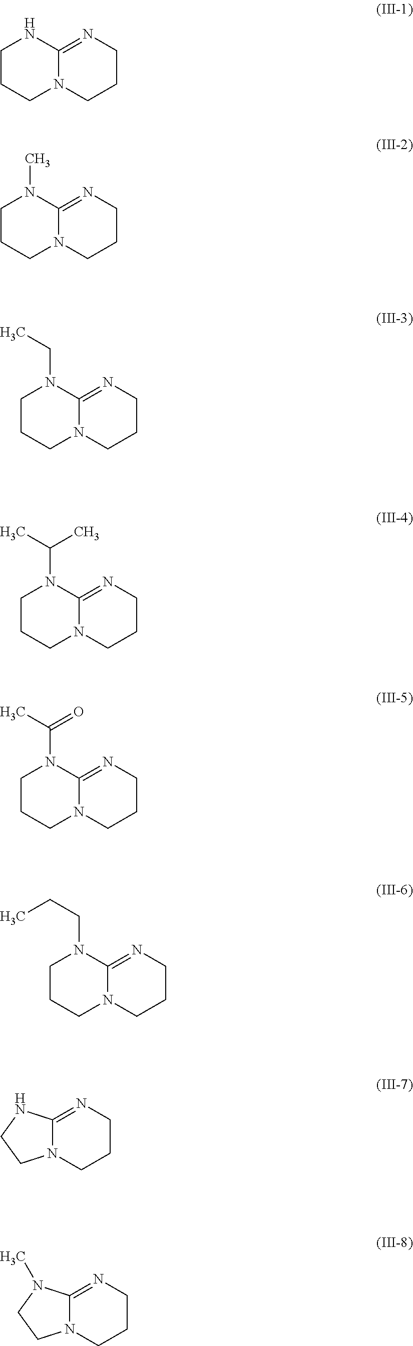

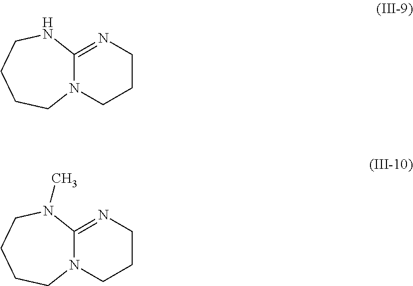

According to the present invention, among the compounds represented by formulae (I) to (III), the relief-forming layer may contain at least one of them, and may contain two or more of them. Furthermore, the relief-forming layer may contain two or more kinds of the compounds represented by the formula (I), or may contain a compound represented by the formula (I) and a compound represented by the formula (II), without any particular limitations.

According to the present invention, as (Component C) specific amine compound, the compound represented by the formula (I) and the compound represented by the formula (III) are preferred, and the compound represented by the formula (I) is more preferred.

The content of (Component C) specific amine compound in the relief-forming layer is preferably 1 to 100 parts by weight relative to 100 parts by weight of Component A, and from the viewpoint of retaining print performance, the content is more preferably 3 to 50 parts by weight, and yet more preferably 5 to 30 parts by weight.

Furthermore, the content of (Component C) specific amine compound in the relief-forming layer is preferably 0.1 wt % to 40 wt %, more preferably 0.5 wt % to 35 wt %, yet more preferably 1 wt % to 30 wt %, and particularly preferably 5 wt % to 30 wt %, relative to the total weight of the relief-forming layer.

### (Component D) Binder Polymer

The relief-forming layer in the relief printing plate precursor for laser engraving of the present invention preferably contains a binder polymer, from the viewpoint of enhancing the film strength and print durability.

The binder polymer that can be used in the present invention is not particularly limited, but it is preferable that the relief-forming layer include a binder polymer containing, in the molecule, a functional group which is capable of reacting with at least one of the ethylenically unsaturated bonds in Component A described above and forming a crosslinked structure, in view of forming a highly organized three-dimensional crosslinked structure. The functional group which is capable of reacting with at least one of the ethylenically unsaturated bonds in Component A and forming a crosslinked structure, may be an ethylenically unsaturated group, and specific examples thereof include an acryloyl group, a methacryloyl group, an acrylamide group, a methacrylamide group, and a vinyl group.

The binder polymer is a polymer component that is contained in the composition for laser engraving, and general polymer compounds can be appropriately selected and used singly or in combination of two or more kinds. Particularly, when the composition for laser engraving is used in a printing plate precursor, it is necessary to select the binder polymer in consideration of various performances such as laser engravability, ink receptability, and engraving residue dispersibility.

The binder polymer can be selected from a polystyrene resin, a polyester resin, a polyamide resin, a polyurea resin, a polyamideimide resin, a polyurethane resin, a polysulfone resin, a polyether sulfone resin, a polyimide resin, a polycarbonate resin, a hydrophilic polymer containing a hydroxyethylene unit, an acrylic resin, an acetal resin, an epoxy resin, a polycarbonate resin, a vinyl resin, a rubber, a thermoplastic elastomer, and the like, and used. Among these, it is preferable to select the binder polymer from a polycarbonate resin, a polyurethane resin, an acrylic resin, a polyester resin and a vinyl resin, and it is particularly preferable to select the binder polymer from a polycarbonate resin having an ethylenically unsaturated bond, a polyurethane resin, an acrylic resin, a polyester resin, and a vinyl resin.

For example, from the viewpoint of the laser engraving sensitivity, polymers having a partial structure capable of being thermally decomposed by exposure or heating are preferable. Examples of such polymers preferably include those described in JP-A-2008-163081, paragraph 0038. Moreover, for example, when the purpose is to form a film having softness and flexibility, a soft resin or a thermoplastic elastomer is selected. It is described in detail in JP-A-2008-163081, paragraphs 0039 to 0040. Furthermore, in a case where the resin composition for laser engraving is applied to the relief-forming layer in the relief printing plate precursor for laser engraving, from the viewpoint of easy preparation of the composition for the relief-forming layer, and the improvement of resistance properties for an oil-based ink in the obtained relief printing plate, the use of a hydrophilic or alcoholphilic polymer is preferable. As the hydrophilic polymer, those described in detail in JP-A-2008-163081, paragraph 0041 can be used.

In addition, when being used for the purpose of curing by heating and exposure and improving strength, a polymer having a carbon-carbon unsaturated bond in the molecule is preferably used.

As such a polymer, examples of the polymer having an ethylenically unsaturated bond at the main chain include SB (polystyrene-polybutadiene), SBS (polystyrene-polybutadiene-polystyrene), SIS (polystyrene-polyisoprene-polystyrene), and SEBS (polystyrene-polyethylene/polybutylene-polystyrene).

The polymer having a carbon-carbon bond at the side chain can be obtained by introducing a carbon-carbon unsaturated group such as an allyl group, an acryloyl group, a methacryloyl group, a styryl group, and a vinyl ether group into a structure of the binder polymer. As a method of introducing a carbon-carbon unsaturated group into the side chain of the binder polymer, known methods may be employed, such as (1) a method in which structural units having a polymerizable group precursor obtained by bonding a protecting group with a polymerizable group are copolymerized with the polymer and the protecting group is eliminated to obtain a polymerizable group and (2) a method in which a high molecular compound having a plurality of reactive group such as a hydroxy group, an amino group, an epoxy group, and a carboxyl group is prepared and a compound having a group which can react with the reactive group and a carbon-carbon unsaturated group is introduced by polymer reaction. According to these methods, the amount of an unsaturated bond or a polymerizable group introduced into the high molecular compound can be controlled.

The binder polymer that can be used in the present invention is a preferred component to be used in combination in the relief-forming layer constituting the recording layer according to the present invention. When the binder polymer is used in combination with the photothermal conversion agent capable of absorbing light having a wavelength of 700 nm to 1,300 nm as will be described below, it is particularly preferable to use a binder polymer having a glass transition temperature (Tg) of 20° C. or higher, or a binder polymer which has a glass transition temperature (Tg) of 20° C. or lower but has fluidity at 20° C., because the engraving sensitivity is enhanced. A polymer having properties such as described above may also be called a non-elastomer in the following descriptions.

In the case of a binder polymer having a glass transition temperature (Tg) of 20° C. or higher, there are no particular limitations on the upper limit of the glass transition temperature of the binder polymer, but a binder polymer having a glass transition temperature of lower than 200° C. is preferred from the viewpoint of handleability, and a binder polymer having a glass transition temperature of 25° C. to 120° C. is more preferred. Furthermore, in the case of a binder polymer which has a glass transition temperature (Tg) of 20° C. or lower but has fluidity at 20° C., the lower limit of the glass transition temperature of the binder polymer is not limited, but a binder polymer having a glass transition temperature of −50° C. or higher is preferred from the viewpoint of handleability, and a binder polymer having a glass transition temperature of −25° C. to 10° C. is more preferred.

Hereinafter, resins that are suitably used as Component D will be described.

### (1) Polycarbonate Resin

As the polycarbonate resin, it is preferable to use a polycarbonate polyol and modification products thereof, and examples thereof include a polymer obtainable by allowing a polyol component to react with a carbonate compound such as a dialkyl carbonate, an alkylene carbonate, or a diaryl carbonate, and modification products thereof.

As the polyol component, compounds that are generally used in the production of a polycarbonate polyol can be used, and examples thereof include aliphatic diols having 2 to 15 carbon atoms, such as ethylene glycol, diethylene glycol, triethylene glycol, propylene glycol, 1,3-propanediol, 2-methyl-1,3-propanediol, 2,2-diethyl-1,3-propanediol, 1,3-butanediol, 1,4-butanediol, 2-methyl-1,4-butanediol, neopentyl glycol, 1,5-pentanediol, 3-methyl-1,5-pentanediol, 1,6-hexanediol, 1,7-heptanediol, 1,8-octanediol, 2-methyl-1,8-octanediol, 2,7-dimethyl-1,8-octanediol, 1,9-nonanediol, 2-methyl-1,9-nonanediol, 2,8-dimethyl-1,9-nonanediol, and 1,10-decanediol; alicyclic diols such as 1,4-cyclohexanediol, cyclohexanedimethanol, and cyclooctanedimethanol; aromatic diols such as 1,4-bis(β-hydroxyethoxy)benzene; and polyhydric alcohols having three or more hydroxyl groups per molecule, such as trimethylolpropane, trimethylolethane, glycerin, 1,2,6-hexanetriol, pentaerythritol, and diglycerin. In the production of a polycarbonate polyol, such a polyol component may be used alone, or two or more kinds may be used in combination.

Among these, for the production of a polycarbonate polyol, it is preferable to use an aliphatic diol having 5 to 12 carbon atoms and having a methyl group as a side chain, such as 2-methyl-1,4-butanediol, 3-methyl-1,5-pentanediol, 2-methyl-1,8-octanediol, 2,7-dimethyl-1,8-octanediol, 2-methyl-1,9-nonanediol, or 2,8-dimethyl-1,9-nonanediol, as the polyol component. Particularly, it is preferable to use such an aliphatic diol having 5 to 12 carbon atoms and having a methyl group as a side chain at a proportion of 30 mol % or more of the total amount of the polyol components used in the production of the polyester polyol, and more preferably at a proportion of 50 mol % or more of the total amount of polyol components.

Furthermore, examples of the dialkyl carbonate include dimethyl carbonate and diethyl carbonate, and examples of the alkylene carbonate include ethylene carbonate. Examples of the diaryl carbonate include diphenyl carbonate.

Examples of the polyester polycarbonate polyol described above include a polymer obtainable by allowing a polyol component, a polycarboxylic acid component and a carbonate compound to simultaneously react; a polymer obtainable by allowing a polyester polyol and a polycarbonate polyol that have been synthesized in advance to react with a carbonate compound; and a polymer obtainable by allowing a polyester polyol and a polycarbonate polyol that have been synthesized in advance to react with a polyol component and a polycarboxylic acid component.

Furthermore, the polycarbonate diol can be produced by a known method in the related art such as the method described in, for example, JP-B-5-29648 (JP-B denotes a Japanese examined patent application publication), but specifically, the polycarbonate diol can be produced by a transesterification reaction between a diol and a carbonic acid ester.

The polycarbonate resin preferably contains, in the molecule, a functional group which reacts with at least one of the ethylenically unsaturated bonds in Component A described above and forms a crosslinked structure. More specifically, an example thereof may be a polymer obtainable by modifying a polycarbonate polyol and introducing an ethylenically unsaturated group into a side chain or the main chain. An ethylenically unsaturated group can be introduced by allowing a polycarbonate polyol to react with a compound having a group which is capable of reacting with a hydroxyl group that is carried by a polycarbonate polyol and an ethylenically unsaturated group.

The number average molecular weight of the polycarbonate resin is preferably in the range of 1,000 to 200,000, more preferably in the range of 1,500 to 10,000, and yet more preferably in the range of 2,000 to 8,000.

### (2) Polyurethane Resin

According to the present invention, a polyurethane resin can be used as Component D. Meanwhile, the polyurethane resin preferably contains, in the molecule, a functional group which is capable of reacting with at least one of the ethylenically unsaturated bonds in Component A described above and forming a crosslinked structure.

The polyurethane resin is formed by allowing at least one polyisocyanate to react with at least one polyhydric alcohol component.

The polyurethane resin preferably includes a polycarbonate diol formed from a repeating unit represented by formula (4):

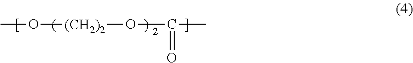

The repeating unit of the formula (4) may contain a linear and/or branched molecular chain. The polycarbonate diol can be produced from a corresponding diol by a known method (for example, JP-B-5-29648).

The polyurethane resin preferably further has at least one bond selected from a urethane bond and an ester bond in the molecule. When the polyurethane resin has the bonds described above, the resistance of a printing plate to an ink cleaning agent containing an ester-based solvent or an ink cleaning agent containing a hydrocarbon-based solvent, which are used in printing, tends to improve, which is preferable.

The method for producing a polyurethane resin is not particularly limited, and for example, a method of allowing a compound having a carbonate bond or an ester bond, and having plural reactive groups such as a hydroxyl group, an amino group, an epoxy group, a carboxyl group, an acid anhydride group, a ketone group, a hydrazine residue, an isocyanate group, an isothiocyanate group, a cyclic carbonate group, or an alkoxycarbonyl group, with a molecular weight of about several thousands, to react with a compound having plural functional groups that are capable of bonding with the reactive groups (for example, a polyisocyanate having a hydroxyl group, an amino group or the like), and performing regulation of the molecular weight and conversion of the molecular terminal to bondable groups, and the like can be used.

Examples of the diol compound having a carbonate bond, which is used in the production of a polyurethane resin, include aliphatic polycarbonate diols such as 4,6-polyalkylene carbonate diol, 8,9-polyalkylene carbonate diol, and 5,6-polyalkylene carbonate diol. Furthermore, an aliphatic polycarbonate diol having an aromatic molecular structure in the molecule may also be used. When the hydroxyl groups at the terminal of these compounds are subjected to a condensation reaction with a diisocyanate compound such as tolylene diisocyanate, diphenylmethane diisocyanate, hexamethylene diisocyanate, isophorone diisocyanate, dicyclohexylmethane diisocyanate, tetramethylxylene diisocyanate, xylene diisocyanate, naphthalene diisocyanate, trimethylhexamethylene diisocyanate, p-phenylene diisocyanate, cyclohexylene diisocyanate, lysine diisocyanate, or triphenylmethane diisocyanate; or a triisocyanate compound such as triphenylmethane triisocyanate, 1-methylbenzene-2,4,6-triisocyanate, naphthalene-1,3,7-triisocyanate, or biphenyl-2,4,4′-triisocyanate, a urethane bond can be introduced to the compounds.

Furthermore, when a polyurethane resin is produced, a polysiloxane polyol may be used as the polyhydric alcohol, and when a polysiloxane polyol and a polyisocyanate compound that will described below are used, a polyurethane resin having a siloxane bond in the molecule can be synthesized.

The polyurethane resin is a resin having a number average molecular weight of preferably 1,000 to 50,000, more preferably 1,000 to 45,000, yet more preferably 1,000 to 40,000, and particularly preferably 2,000 to 40,000. Since the strength of the printing plate is enhanced and the printing plate tends to withstand repeated use, the number average molecular weight of the polyurethane resin is preferably 1,000 or greater. Meanwhile, because the viscosity of the composition at the time of molding processing does not excessively increase, there is a tendency for the printing plate to be more easily produced. Therefore, the number average molecular weight of the polyurethane resin is preferably 50,000 or less.

### (3) Acrylic Resin

In the present invention, as binder polymer, an acrylic resin may be used.

As acrylic resin, acrylic resin having hygroxy group is preferable.

The acrylic resin is not particularly limited, only if it is an acrylic resin obtained using a known acrylic monomer. The acrylic resin preferably has a functional group, which can form a crosslinking structure reacted with at least one ethylenically unsaturated bond of Component A above-mentioned, in the molecule.

Examples thereof such an acrylic monomer include a (meth)acrylic ester, and specific examples of the (meth)acrylic ester include methyl(meth)acrylate, ethyl(meth)acrylate, n-propyl(meth)acrylate, isopropyl(meth)acrylate, n-butyl(meth)acrylate, isobutyl(meth)acrylate, tert-butyl(meth)acrylate, n-hexyl(meth)acrylate, 2-ethylhexyl(meth)acrylate, acetoxyethyl(meth)acrylate, phenyl(meth)acrylate, 2-methoxyethyl(meth)acrylate, 2-ethoxyethyl(meth)acrylate, 2-(2-methoxyethoxy)ethyl(meth)acrylate, cyclohexyl(meth)acrylate, benzyl(meth)acrylate, diethylene glycol monomethyl ether(meth)acrylate, diethylene glycol monoethyl ether(meth)acrylate, diethylene glycol monophenyl ether(meth)acrylate, triethylene glycol monomethyl ether(meth)acrylate, triethylene glycol monoethyl ether(meth)acrylate, dipropylene glycol monomethyl ether(meth)acrylate, polyethylene glycol monomethyl ether(meth)acrylate, polypropylene glycol monomethyl ether(meth)acrylate, the monomethyl ether(meth)acrylate of a copolymer of ethylene glycol and propylene glycol, N,N-dimethylaminoethyl(meth)acrylate, N,N-diethylaminoethyl(meth)acrylate, N,N-dimethylaminopropyl(meth)acrylate, 2-hydroxyethyl(meth)acrylate, 2-hydroxypropyl(meth)acrylate, and 4-hydroxybutyl(meth)acrylate

Furthermore, a modified acrylic resin formed with a urethane group- or urea group-containing acrylic monomer may preferably be used.

Among them, from the viewpoint of ink transfer properties, an alkyl(meth)acrylate such as lauryl(meth)acrylate and 2-ethylhexyl(meth)acrylate, a (meth)acrylate having ether bond in side chain such as polyethyleneglycol monomethyl ether(meth)acrylate and polypropyleneglycol monomethyl ether(meth)acrylate, and an aliphatic cyclic structure-containing (meth)acrylate such as t-butylcyclohexyl(meth)acrylate are particularly preferable.

The number average molecular weight of the acrylic resin is preferably in the range of 1,000 to 100,000, more preferably 3,000 to 80,000, and yet more preferably 5,000 to 70,000. When the number average molecular weight of the acrylic resin is in the range described above, a relief-forming layer and a relief layer which have excellent flexibility are obtained.

### (4) Polyester Resin

The polyester resin is a resin that is formed by an esterification reaction or a transesterification reaction between at least one polybasic acid component and at least one polyhydric alcohol component. The polyester resin preferably contains, in the molecule, a functional group that is capable of reacting with at least one of the ethylenically saturated bonds in Component A described above and forming a crosslinked structure.

Specific examples of the polybasic acid component include dibasic acids such as phthalic acid, isophthalic acid, terephthalic acid, tetrahydrophthalic acid, hexahydrophthalic acid, succinic acid, fumaric acid, adipic acid, sebacic acid, and maleic acid; trivalent or higher-valent polybasic acids such as trimellitic acid, methylcyclohexene tricarboxylic acid, and pyromellitic acid; and acid anhydrides thereof, for example, phthalic anhydride, tetrahydrophthalic anhydride, hexahydrophthalic anhydride, maleic anhydride, trimellitic anhydride, and pyromellitic anhydride.

As the polybasic acid component, one or more dibasic acids selected from the dibasic acids described above, lower alkyl ester compounds of these acids, and acid anhydrides are mainly used. Furthermore, if necessary, a monobasic acid such as benzoic acid, crotonic acid or p-t-butylbenzoic acid; a trivalent or higher-valent polybasic acid such as trimellitic anhydride, methylcyclohexene tricarboxylic acid or pyromellitic anhydride; or the like can be further used in combination.

The polybasic acid component according to the present invention preferably includes at least adipic acid, from the viewpoint of ink transfer properties.

Specific examples of the polyhydric alcohol component include divalent alcohols such as ethylene glycol, diethylene glycol, propylene glycol, dipropylene glycol, 1,4-butanediol, neopentyl glycol, 1,5-pentanediol, 3-methylpentanediol, 1,4-hexanediol, and 1,6-hexanediol; and trivalent or higher-valent polyhydric alcohols such as glycerin, trimethylolethane, trimethylolpropane, and pentaerythritol.

As the polyhydric alcohol component, the divalent alcohols described above are mainly used, and if necessary, trivalent or higher-valent polyhydric alcohols such as glycerin, trimethylolethane, trimethylolpropane, and pentaerythritol can be further used in combination. These polyhydric alcohols can be used individually, or as mixtures of two or more kinds.

The polyhydric alcohol component according to the present invention preferably includes at least 3-methylpentanediol, from the viewpoint of storage stability.

The esterification reaction or transesterification reaction of the polybasic acid component and the polyhydric alcohol component can be carried out by using a usually used method without particular limitations.

The number average molecular weight of the polyester resin is preferably in the range of 1,000 to 100,000. The number average molecular weight is more preferably 1,000 to 50,000, yet more preferably 1,000 to 20,000, and particularly preferably 2,000 to 20,000. When the number average molecular weight of the polyester resin is in the range described above, a relief-forming layer and a relief layer which have excellent flexibility are obtained.

### (5) Vinyl Resin

In the present invention, as Component D, a vinyl resin may be used, and the vinyl resin is preferably polyvinyl alcohol, polyvinyl acetal, and derivatives thereof. In this description, hereinafter, polyvinyl acetal and derivatives thereof are called just a polyvinyl acetal derivative. That is, a polyvinyl acetal derivative includes polyvinyl acetal and derivatives thereof, and is a generic term used to refer to compounds obtained by converting polyvinyl alcohol (obtained by saponifying polyvinyl acetate) into a cyclic acetal.

The acetal content in the polyvinyl acetal derivative (mole % of vinyl alcohol units converted into acetal relative to the total number of moles of vinyl acetate monomer starting material as 100 mol %) is preferably 30 to 90 mol %, more preferably 50 to 85 mol %, and particularly preferably 55 to 78 mol %.

The vinyl alcohol unit in the polyvinyl acetal is preferably 10 to 70 mol % relative to the total number of moles of the vinyl acetate monomer starting material, more preferably 15 to 50 mol %, and particularly preferably 22 to 45 mol %.

Furthermore, the polyvinyl acetal may have a vinyl acetate unit as another component, and the content thereof is preferably 0.01 to 20 mol %, and more preferably 0.1 to 10 mol %. The polyvinyl acetal derivative may further have another copolymerized constitutional unit.

Examples of the polyvinyl acetal derivative include a polyvinyl butyral derivative, a polyvinyl propylal derivative, a polyvinyl ethylal derivative, and a polyvinyl methylal derivative. Among them, a polyvinyl butyral derivative (hereinafter, it is also referred to as a “PVB derivative”) is a derivative that is preferable. In this description, for examples, a polyvinyl butyral derivative includes polyvinyl butyral and derivatives thereof, and the same can be said for other polyvinyl acetal derivatives.

From the viewpoint of a balance being achieved between engraving sensitivity and film formation properties, the weight-average molecular weight of the polyvinyl acetal derivative is preferably 5,000 to 800,000, more preferably 8,000 to 500,000 and, from the viewpoint of improvement of rinsing properties for engraving residue, particularly preferably 50,000 to 300,000.

Hereinafter, polyvinyl butyral and derivatives thereof are cited for explanation as particularly preferable examples of polyvinyl acetal, but are not limited to these.

Polyvinyl butyral has a structure as shown below, and is constituted while including these structural units.

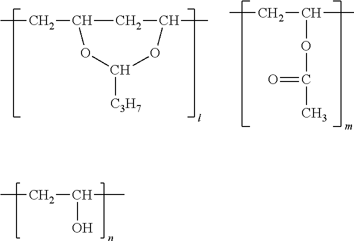

The PVB derivative is also available as a commercial product, and preferred examples thereof include, from the viewpoint of alcohol dissolving capability (particularly, ethanol), “S-REC B” series and “S-REC K (KS)” series manufactured by SEKISUI CHEMICAL CO., LTD. and “DENKA BUTYRAL” manufactured by DENKI KAGAKU KOGYO KABUSHIKI KAISHA. From the viewpoint of alcohol dissolving capability (particularly, ethanol), “S-REC B” series manufactured by SEKISUI CHEMICAL CO., LTD. and “DENKA BUTYRAL” manufactured by DENKI KAGAKU KOGYO KABUSHIKI KAISHA are more preferable. Among these, particularly preferable commercial products are shown below along with the values l, m, and n in the above formulae and the molar weight. Examples of “S-REC B” series manufactured by SEKISUI CHEMICAL CO., LTD. include “BL-1” (l=61, m=3, n=36, weight-average molecular weight: 19,000), “BL-1H” (l=67, m=3, n=30, weight-average molecular weight: 20,000), “BL-2” (l=61, m=3, n=36, weight-average molecular weight: about 27,000), “BL-5” (l=75, m=4, n=21, weight-average molecular weight: 32,000), “BL-S” (l=74, m=4, n=22, weight-average molecular weight: 23,000), “BM-S” (l=73, m=5, n=22, weight-average molecular weight: 53,000), and “BH-S” (l=73, m=5, n=22, weight-average molecular weight: 66,000), and examples of “DENKA BUTYRAL” manufactured by DENKI KAGAKU KOGYO include “#3000-1” (l=71, m=1, n=28, weight-average molecular weight: 74,000), “#3000-2” (l=71, m=1, n=28, weight-average molecular weight: 90,000), “#3000-4” (l=71, m=1, n=28, weight-average molecular weight: 117,000), “#4000-2” (l=71, m=1, n=28, weight-average molecular weight: 152,000), “#6000-C” (l=64, m=1, n=35, weight-average molecular weight: 308,000), “#6000-EP” (l=56, m=15, n=29, weight-average molecular weight: 381,000), “#6000-CS” (l=74, m=1, n=25, weight-average molecular weight: 322,000), and “#6000-AS” (l=73, m=1, n=26, weight-average molecular weight: 242,000).

When the relief-forming layer is formed using the PVB derivative as Component D, a method of casting and drying a solution in which a solvent is dissolved is preferable from the viewpoint of smoothness of the film surface.

### (6) Polysiloxane Polyol

According to the present invention, a polysiloxane polyol can be used as Component D. In regard to the polysiloxane polyol, if the polysiloxane polyol has two or more hydroxyl groups, the upper limit is not particularly limited, but the number of hydroxyl groups is preferably 2 to 6, more preferably 2 to 4, yet more preferably 2 to 3, and particularly preferably 2. If there are less than two hydroxyl groups in one molecule of the polysiloxane polyol, the polysiloxane polyol cannot sufficiently react with Component G. When there are 6 or less active hydrogen atoms in one molecule of the polysiloxane polyol, the printing plate precursor thus obtainable has excellent rinsing properties, which is preferable.

The polysiloxane polyol needs to contain a siloxane bond in the molecule.

### (Siloxane Bond)

The siloxane bond will be described. The siloxane bond means a molecular structure in which silicon (Si) and oxygen (O) are alternately bonded.

The details of the mechanism by which the relief printing plate obtained by using the composition of the present invention acquires excellent ink transfer properties, are not clearly understood, but it is speculated that due to the siloxane bond that is stably bonded to polysiloxane polyol, the affinity to the ink is lower as compared with the siloxane bond that is added as an additive, and therefore, ink transfer properties are enhanced.

It is preferable that the polysiloxane polyol be obtainable from a silicone compound represented by the following average composition formula (3):

RₚQᵣXₛSiO_{(4-p-r-s)/2} (3)

In the formula (3), R represents one kind or two or more kinds of hydrocarbon groups selected from the group consisting of an alkyl group having 1 to 30 carbon atoms (carbon number before substitution) substituted with a linear or branched alkyl group having 1 to 30 carbon atoms, a cycloalkyl group having 5 to 20 carbon atoms, an alkoxy group having 1 to 20 carbon atoms or an aryl group having 6 to 20 carbon atoms, an aryl group having 6 to 20 carbon atoms substituted with a halogen atom, an alkoxycarbonyl group having 2 to 30 carbon atoms, a monovalent group containing a carboxyl group or a salt thereof, a monovalent group containing a sulfo group or a salt thereof, and a polyoxyalkylene group; Q and X independently represent one kind or two or more kinds of hydrocarbon groups selected from the group consisting of a hydrogen atom, an alkyl group having 1 to 30 carbon atoms substituted with a linear or branched alkyl group having 1 to 30 carbon atoms, a cycloalkyl group having 5 to 20 carbon atoms, an alkoxy group having 1 to 20 carbon atoms or an aryl group having 6 to 20 carbon atoms, an aryl group having 6 to 20 carbon atoms substituted with a halogen atom, an alkoxycarbonyl group having 2 to 30 carbon atoms, a monovalent group containing a carboxyl group or a salt thereof, a monovalent group containing a sulfo group or a salt thereof, and a polyoxyalkylene group; and p, r and s are numbers that satisfy the relations: 0<p<4, 0≦r<4, 0≦s<4, and (p+r+s)<4.

According to the present exemplary embodiment, the polysiloxane polyol is obtained from a compound having a siloxane bond which is intended to introduce a siloxane bond.

The compound having a siloxane bond which is intended to introduce a siloxane bond may be, for example, a silicone oil. Examples of the silicone oil include low-viscosity to high-viscosity organopolysiloxanes such as dimethylpolysiloxane, methylphenylpolysiloxane, methyl hydrogen polysiloxane, dimethylsiloxane and methylphenylsiloxane copolymers; cyclic siloxanes such as octamethylcyclotetrasiloxane, decamethylcyclopentasiloxane, dodecamethylcyclohexasiloxane, tetramethyltetrahydrogencyclotetrasiloxane, and tetramethyltetraphenylcyclotetrasiloxane; silicone rubbers such as gum-like dimethylpolysiloxanes having high degrees of polymerization, gum-like dimethylsiloxanes, and methylphenylsiloxane copolymers, and cyclic siloxane solutions of silicone rubbers; cyclic siloxane solutions of trimethylsiloxysilicic acid and trimethylsiloxysilicic acid; higher alkoxy-modified silicones such as stearoxysilicones; and higher fatty acid-modified silicones.

The polysiloxane polyol according to the present invention is obtained by modifying the compounds having siloxane bonds described above.

Examples include carbinol-modified silicone oils, phenol-modified silicone oils, silanol-modified silicone oils, and diol-modified silicone oils. Two or more of these silicone oils having hydroxyl groups can be used.

Among the silicone oils having two or more hydroxyl groups in the molecule, both terminal-modified silicone oils are preferred. Examples thereof include both terminal-carbinol-modified silicone oils, both terminal-phenol-modified silicone oils, and both terminal-silanol-modified silicone oils.

Furthermore, single terminal-modified silicone oils or side chain-modified silicone oils can also be used. Examples thereof include single terminal-diol-modified silicone oils, and side chain-carbinol-modified silicone oils.

Among them, from the viewpoints of reactivity, and handleability such as odor or irritability, both terminal-carbinol-modified silicone oils and single terminal-diol-modified silicone oils are preferred; both terminal-carbinol-modified silicone oils and single terminal-diol-modified silicone oils are more preferred; and both terminal-carbinol-modified silicone oils are yet more preferred.

Furthermore, the number average molecular weight of the polysiloxane polyol is preferably 1,000 to 30,000, more preferably 1,000 to 20,000, and yet more preferably 2,000 to 20,000. When the number average molecular weight is in this range, ink transfer properties due to siloxane bonds are sufficiently exhibited, and since there is a tendency that fluidity and compatibility of polysiloxane polyols with Component G can be secured, handling is facilitated, which is preferred. The number average molecular weight as used herein means a value measured by using gel permeation chromatography (GPC) and calibrated relative to standard polystyrenes having already known molecular weights.

As the polysiloxane polyol, commercially available products can also be employed, and examples include, as both terminal-carbinol-modified silicone oils, X-22-160AS, KF-6003 (all manufactured by Shin-Etsu Chemical Co., Ltd.), and BY 16-004 (manufactured by Dow Corning Toray Co., Ltd.); and as single terminal-diol-modified silicone oils, X-22-176DX and X-22-176F (all manufactured by Shin-Etsu Chemical Co., Ltd.).

Furthermore, in order to obtain a polymer having a carbon-carbon unsaturated bond in the main chain or at the end of a side chain, a carbon-carbon unsaturated bond such as an allyl group, an acryloyl group, a methacryloyl group, a styryl group, or a vinyl ether group may also be introduced to the skeleton of the polymer.

The weight average molecular weight (measured by GPC and calculated relative to polystyrene standards) of the binder polymer that can be used in the present invention is preferably 5,000 to 1,000,000, more preferably 8,000 to 750,000, and most preferably 10,000 to 500,000.

The content of the binder polymer in the relief-forming layer is preferably in the range of 0 wt % to 80 wt %, more preferably 5 wt % to 60 wt %, and particularly preferably 10 wt % to 40 wt %, relative to the total weight of the relief-forming layer, from the viewpoint of satisfying the shape retention of the film, water resistance and engraving sensitivity in a well-balanced manner.

### (Component E) Silica Particles

Component E is an optional component for the composition for laser engraving of the present invention, and is silica particles. According to the present invention, there are no particular limitations on the particle size of these silica particles, and the number average particle size is preferably 0.01 μm to 10 μm, more preferably 0.5 μm to 8 μm, and yet more preferably 1 μm to 5 μm.

When the number average particle size is in the range described above, the surface stickiness (tackiness) of the plate surface before and after engraving can be suppressed, the effect of the particle size on the surface roughness of the printing plate or film uniformity is small, and pattern formation by laser engraving can be achieved without causing defects in the printed images.

The number average particle size of Component E in the present invention can be determined by using a known method, for example, transmission electron microscopy (TEM). The number average particle size is measured by using a TEM image analysis.

As the silica particles used as Component E, known silica particles can be used, and may also be produced by any method that is known to those skilled in the art. The silica particles are produced by high temperature processes, for example, a sol-gel process, a hot water process, a plasma process, and a method of producing a fumed metal oxide or a sedimented metal oxide.

When Component E is incorporated, fluidity of the composition for laser engraving is improved, and performance such as engraving residue dispersibility at the time of laser engraving can be improved.

According to the present invention, the concentration of the silica particles is preferably 0.1 wt % to 25 wt %, more preferably 0.1 wt % to 15 wt %, and yet more preferably 0.5 wt % to 10 wt %, relative to the total weight of the relief-forming layer. When the concentration of the silica particles is 0.1 wt % to 25 wt %, satisfactory laser engravability is obtained by suppressing the engraving residue scattering properties, and the image quality is not impaired.

### (Component F) Photothermal Conversion Agent Capable of Absorbing Light Having a Wavelength of 700 to 1,300 nm

The relief-forming layer in the relief printing plate precursor for laser engraving of the present invention preferably further includes (Component F) a photothermal conversion agent capable of absorbing light having a wavelength of 700 to 1,300 nm (hereinafter, simply called “photothermal conversion agent”). That is, it is considered that the photothermal conversion agent in the present invention can promote the thermal decomposition of a cured material during laser engraving by absorbing laser light and generating heat. Therefore, it is preferable that a photothermal conversion agent capable of absorbing light having a wavelength of laser used for graving be selected.

When a laser (a YAG laser, a semiconductor laser, a fiber laser, a surface emitting laser, etc.) emitting infrared at a wavelength of 700 to 1,300 nm is used as a light source for laser engraving, it is preferable for the relief printing plate precursor for laser engraving in the present invention to comprise a photothermal conversion agent that has a maximum absorption wavelength at 700 to 1,300 nm.

As Component F in the present invention, various types of dye or pigment are used.

With regard to the photothermal conversion agent, examples of dyes that can be used include commercial dyes and known dyes described in publications such as ‘Senryo Binran’ (Dye Handbook) (Ed. by The Society of Synthetic Organic Chemistry, Japan, 1970). Specific examples include dyes having a maximum absorption wavelength at 700 to 1,300 nm, and preferable examples include azo dyes, metal complex salt azo dyes, pyrazolone azo dyes, naphthoquinone dyes, anthraquinone dyes, phthalocyanine dyes, carbonium dyes, diimmonium compounds, quinone imine dyes, methine dyes, cyanine dyes, squarylium colorants, pyrylium salts, and metal thiolate complexes. In particular, cyanine-based colorants such as heptamethine cyanine colorants, oxonol-based colorants such as pentamethine oxonol colorants, and phthalocyanine-based colorants are preferably used. Examples include dyes described in paragraphs 0124 to 0137 of JP-A-2008-63554.

With regard to the photothermal conversion agent used in the present invention, examples of pigments include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saishin Ganryo Ouyogijutsu’ (Latest Applications of Pigment Technology) (CMC Publishing, 1986), ‘Insatsu Inki Gijutsu’ (Printing Ink Technology) (CMC Publishing, 1984). Examples of pigments include pigments described in paragraphs 0122 to 0125 of JP-A-2009-178869.

Among these pigments, carbon black is preferable.

Any carbon black, regardless of classification by ASTM (American Society for Testing and Materials) and application (e.g. for coloring, for rubber, for dry cell, etc.), may be used as long as dispersibility, etc. in the resin composition for laser engraving is stable. Carbon black includes for example furnace black, thermal black, channel black, lamp black, and acetylene black. In order to make dispersion easy, a black colorant such as carbon black may be used as color chips or a color paste by dispersing it in nitrocellulose or a binder in advance using, as necessary, a dispersant, and such chips and paste are readily available as commercial products. Examples of carbon black include carbon blacks described in paragraphs 0130 to 0134 of JP-A-2009-178869.

The content of (Component F) the photothermal conversion agent that is capable of absorbing light having a wavelength of 700 nm to 1,300 nm, in the relief-forming layer may vary greatly with the magnitude of the molecular extinction coefficient inherent to the molecule, but the content is preferably 0.01 wt % to 30 wt %, more preferably 0.05 wt % to 20 wt %, and particularly preferably 0.1 wt % to 10 wt %, relative to the total weight of the relief-forming layer.

### <Other Additives>

The relief-forming layer in the relief printing plate precursor for laser engraving of the present invention may include as appropriate various types of known additives other than Component A to F as long as the effects of the present invention are not inhibited. Examples include a fragrance, a polymerizable compound, a polymerization initiator, a plasticizer, a filler, a wax, a process oil, an organic acid, an a metal oxide, an antiozonant, an anti-aging agent, a thermopolymerization inhibitor, and a colorant, and one type thereof may be used on its own or two more types may be used in combination.

The relief-forming layer may include a solvent used in forming a layer as described later as long as the content thereof is not a content without an influence on laser engraving and using for relief printing plate, and preferably include no solvent or less than 0.1 wt % if included.

The resin composition for laser engraving of the present invention may contain a plasticizer.

The plasticizer is a material having the function of softening the film formed with the resin composition for laser engraving, and has necessarily a good compatibility relative to the binder polymer.

As the plasticizer, for example, dioctyl phthalate, didodecyl phthalate, polyethylene glycols, and polypropylene glycols (such as monool type and diol type) are used preferably.

The resin composition for laser engraving of the present invention preferably comprises, as an additive for improving engraving sensitivity, nitrocellulose or a high thermal conductivity material.

Since nitrocellulose is a self-reactive compound, it generates heat during laser engraving, thus assisting thermal decomposition of a coexisting binder polymer such as a hydrophilic polymer. It is surmised that as a result, the engraving sensitivity improves.

A high thermal conductivity material is added for the purpose of assisting heat transfer, and examples of thermally conductive materials include inorganic compounds such as metal particles and organic compounds such as a conductive polymer. As the metal particles, fine gold particles, fine silver particles, and fine copper particles having a particle diameter of on the order of a micrometer or a few nanometers are preferable. As the conductive polymer, a conjugated polymer is particularly preferable, and specific examples thereof include polyaniline and polythiophene.

Moreover, the use of a cosensitizer can furthermore improve the sensitivity in curing the resin composition for laser engraving with light.

Furthermore, a small amount of thermal polymerization inhibitor is added preferably for the purpose of hindering unnecessary thermal polymerization of a polymerizable compound during the production or storage of the composition.

For the purpose of coloring the resin composition for laser engraving, a colorant such as a dye or a pigment may be added. This enables properties such as visibility of an image area or suitability for an image densitometer to improve.

Furthermore, in order to improve physical properties of the thermally cured layer, a known additive such as a filler may be added.

The relief-forming layer is a layer containing at least Component A to C, and is a crosslinkable layer.

As a mode in which a relief printing plate is prepared using the relief printing plate precursor for laser engraving, a mode in which a relief printing plate is prepared by crosslinking a relief-forming layer to thus form a relief printing plate precursor having a crosslinked relief-forming layer, and the crosslinked relief-forming layer (hard relief-forming layer) is then laser-engraved to thus form a relief layer is preferable. By crosslinking the relief-forming layer, it is possible to prevent abrasion of the relief layer during printing, and it is possible to obtain a relief printing plate having a relief layer with a sharp shape after laser engraving.

The relief-forming layer may be formed by molding the resin composition for laser engraving that has the above-mentioned components for a relief-forming layer into a sheet shape or a sleeve shape. The relief-forming layer is usually provided above a support, which is described later, but it may be formed directly on the surface of a member such as a cylinder of equipment for plate making or printing or may be placed and immobilized thereon, and a support is not always required.

A case in which the relief-forming layer is mainly formed in a sheet shape is explained as an example below.

### <Adhesive Layer>

An adhesive layer may be provided between the relief-forming layer and the support for the purpose of strengthening the adhesion between the two layers. Examples of materials (adhesives) that can be used in the adhesive layer include those described in ‘Handbook of Adhesives’, Second Edition, Ed by I. Skeist, (1977).

### <Protection Film, Slip Coat Layer>

For the purpose of preventing scratches or dents in the relief-forming layer surface or the crosslinked relief-forming layer surface, a protection film may be provided on the relief-forming layer surface or the crosslinked relief-forming layer surface. The thickness of the protection film is preferably 25 to 500 μm, and more preferably 50 to 200 μm. The protection film may employ, for example, a polyester-based film such as PET or a polyolefin-based film such as PE (polyethylene) or PP (polypropylene). The surface of the film may be made matte. The protection film is preferably peelable.

When the protection film is not peelable or conversely has poor adhesion to the relief-forming layer, a slip coat layer may be provided between the two layers. The material used in the slip coat layer preferably employs as a main component a resin that is soluble or dispersible in water and has little tackiness, such as polyvinyl alcohol, polyvinyl acetate, partially saponified polyvinyl alcohol, a hydroxyalkylcellulose, an alkylcellulose, or a polyamide resin.

### <Process for Producing Relief Printing Plate Precursor for Laser Engraving>

Formation of a relief-forming layer in the relief printing plate precursor for laser engraving is not particularly limited, and examples thereof include a method in which a composition containing at least Component A to C is prepared, solvent is removed as necessary from this resin composition for laser engraving, and it is melt-extruded onto a support. Alternatively, a method may be employed in which the resin composition for laser engraving is cast onto a support, and this is dried in an oven to thus remove solvent from the resin composition.

Among them, the process for making a relief printing plate for laser engraving of the present invention is preferably a production process comprising a layer formation step of forming a relief-forming layer from a composition containing at least Component A to C.

The process for making a relief printing plate for laser engraving of the present invention is preferably a production process comprising a layer formation step of forming a relief-forming layer from a composition containing at least Component A to C and a crosslinking step of crosslinking the relief-forming layer by means of heat and/or light to thus obtain a relief printing plate precursor having a crosslinked relief-forming layer.

Subsequently, as necessary, a protection film may be laminated on the relief-forming layer. Laminating may be carried out by compression-bonding the protection film and the relief-forming layer by means of heated calendar rollers, etc. or putting a protection film into intimate contact with a relief-forming layer whose surface is impregnated with a small amount of solvent.

When a protection film is used, a method in which a relief-forming layer is first layered on a protection film and a support is then laminated may be employed.

When an adhesive layer is provided, it may be dealt with by use of a support coated with an adhesive layer. When a slip coat layer is provided, it may be dealt with by use of a protection film coated with a slip coat layer.

### <Layer Formation Step>

The process for making the relief printing plate precursor for laser engraving of the present invention preferably comprises a layer formation step of forming a relief-forming layer from a composition containing at least Component A to C.

Preferred examples of a method for forming a relief-forming layer include a method in which a composition containing at least Component A to C is prepared, solvent is removed as necessary from the composition, and it is then melt-extruded onto a support and a method in which the composition is prepared, the resin composition for laser engraving of the present invention is cast onto a support, and this is dried in an oven to thus remove the solvent.

The resin composition for laser engraving may be produced by, for example, dissolving Component A and Component C, and as optional components Component D to Component F in an appropriate solvent, and then dissolving Component B.

The preferable composition used for forming a relief-forming layer may comprise a solvent.

From the viewpoint of dissolving, a solvent used when preparing the composition is preferably mainly an aprotic organic solvent. The aprotic organic solvent may be used on its own or may be used in combination with a protic organic solvent. More specifically, they are used preferably at aprotic organic solvent/protic organic solvent=100/0 to 50/50 (ratio by weight), more preferably 100/0 to 70/30, and particularly preferably 100/0 to 90/10.

Specific preferred examples of the aprotic organic solvent include acetonitrile, tetrahydrofuran, dioxane, toluene, propylene glycol monomethyl ether acetate, methyl ethyl ketone, acetone, methyl isobutyl ketone, ethyl acetate, butyl acetate, ethyl lactate, N,N-dimethylacetamide, N-methylpyrrolidone, and dimethyl sulfoxide.

Specific preferred examples of the protic organic solvent include methanol, ethanol, 1-propanol, 2-propanol, 1-butanol, 1-methoxy-2-propanol, ethylene glycol, diethylene glycol, and 1,3-propanediol.

### <Crosslinking Step>

The process for producing a relief printing plate precursor for laser engraving of the present invention is preferably a production process comprising a crosslinking step of crosslinking the relief-forming layer by means of heat to thus obtain a relief printing plate precursor having a crosslinked relief-forming layer.

The relief-forming layer may be crosslinked by heating the relief printing plate precursor for laser engraving (step of crosslinking by means of heat). As heating means, there can be cited a method in which a printing plate precursor is heated in a hot air oven or a far-infrared oven for a predetermined period of time and a method in which it is put into contact with a heated roller for a predetermined period of time.

Due to the relief-forming layer being crosslinked, firstly, a relief formed after laser engraving becomes sharp and, secondly, tackiness of engraving residue formed when laser engraving is suppressed. If an uncrosslinked relief-forming layer is laser-engraved, residual heat transmitted to an area around a laser-irradiated part easily causes melting or deformation of a part that is not targeted, and a sharp relief layer cannot be obtained in some cases. Furthermore, in terms of general properties of a material, the lower the molecular weight, the more easily it becomes a liquid than a solid, that is, there is a tendency for tackiness to increase. Engraving residue formed when engraving a relief-forming layer tends to have higher tackiness as larger amounts of low-molecular-weight materials are used. Since a polymerizable compound, which is a low-molecular-weight material, becomes a polymer by crosslinking, the tackiness of the engraving residue formed tends to decrease.

As the crosslinking step is a step of carrying out crosslinking by heat, there is the advantage that particularly expensive equipment is not needed, since a printing plate precursor reaches a high temperature, it is necessary to carefully select the starting materials used while taking into consideration the possibility that a thermoplastic polymer, which becomes soft at high temperature, will deform during heating, etc.

During thermal crosslinking, a thermopolymerization initiator may not only be used for crosslinking, but a representative vulcanizing agent may also be used for crosslinking. Thermal crosslinking may also be carried out by adding a heat-curable resin such as for example an epoxy resin as a crosslinking component to a layer.

### (Relief Printing Plate and Process for Making Same)

The process for making a relief printing plate of the present invention preferably comprises an engraving step of laser-engraving relief printing plate precursor for laser engraving of the present invention having the crosslinked relief-forming layer, and more preferably comprises a step (1′) of preparing the relief printing plate precursor having a crosslinked relief-forming layer of the present invention; and a step (2′) of laser-engraving the crosslinked relief-forming layer and thereby forming a relief layer.

The process for making a relief printing plate of the present invention yet more preferably comprises a layer formation step of forming a relief-forming layer from the composition containing at least Component A to C, a crosslinking step of crosslinking the relief-forming layer by means of heat to thus obtain a relief printing plate precursor having a crosslinked relief-forming layer, and an engraving step of laser-engraving the relief printing plate precursor having the crosslinked relief-forming layer.

The relief printing plate of the present invention is a relief printing plate having a relief layer obtained by crosslinking and laser-engraving the relief-forming layer of the relief printing plate precursor for laser engraving of the present invention, and is preferably a relief printing plate made by the process for making a relief printing plate of the present invention.

The layer formation step and the crosslinking step in the process for making a relief printing plate of the present invention mean the same as the layer formation step and the crosslinking step in the above-mentioned process for producing a relief printing plate precursor for laser engraving, and preferred ranges are also the same.

### <Engraving Step>

The process for producing a relief printing plate of the present invention preferably comprises an engraving step of laser-engraving the relief printing plate precursor having a crosslinked relief-forming layer.

The engraving step is a step of laser-engraving a crosslinked relief-forming layer that has been crosslinked in the crosslinking step to thus form a relief layer. Specifically, it is preferable to engrave a crosslinked relief-forming layer that has been crosslinked by irradiation with laser light according to a desired image, thus forming a relief layer. Furthermore, a step in which a crosslinked relief-forming layer is subjected to scanning irradiation by controlling a laser head using a computer in accordance with digital data of a desired image can preferably be cited.

This engraving step preferably employs an infrared laser. When irradiated with an infrared laser, molecules in the crosslinked relief-forming layer undergo molecular vibration, thus generating heat. When a high power laser such as a carbon dioxide laser or a YAG laser is used as the infrared laser, a large quantity of heat is generated in the laser-irradiated area, and molecules in the crosslinked relief-forming layer undergo molecular scission or ionization, thus being selectively removed, that is, engraved. The advantage of laser engraving is that, since the depth of engraving can be set freely, it is possible to control the structure three-dimensionally. For example, for an area where fine halftone dots are printed, carrying out engraving shallowly or with a shoulder prevents the relief from collapsing due to printing pressure, and for a groove area where a fine outline character is printed, carrying out engraving deeply makes it difficult for ink the groove to be blocked with ink, thus enabling breakup of an outline character to be suppressed.

In particular, when engraving is carried out using an infrared laser that corresponds to the absorption wavelength of the photothermal conversion agent, it becomes possible to selectively remove the crosslinked relief-forming layer at higher sensitivity, thus giving a relief layer having a sharp image.

As the infrared laser used in the engraving step, from the viewpoint of productivity, cost, etc., a carbon dioxide laser (a CO₂ laser) or a semiconductor laser is preferable. In particular, a fiber-coupled semiconductor infrared laser (FC-LD) is preferably used. In general, compared with a CO₂ laser, a semiconductor laser has higher efficiency laser oscillation, is less expensive, and can be made smaller. Furthermore, it is easy to form an array due to the small size. Moreover, the shape of the beam can be controlled by treatment of the fiber.

With regard to the semiconductor laser, one having a wavelength of 700 to 1,300 nm is preferable, one having a wavelength of 800 to 1,200 nm is more preferable, one having a wavelength of 860 to 1,200 nm is yet more preferable, and one having a wavelength of 900 to 1,100 nm is particularly preferable.

Furthermore, the fiber-coupled semiconductor laser can output laser light efficiently by being equipped with optical fiber, and this is effective in the engraving step in the present invention. Moreover, the shape of the beam can be controlled by treatment of the fiber. For example, the beam profile may be a top hat shape, and energy can be applied stably to the plate face. Details of semiconductor lasers are described in ‘Laser Handbook 2^{nd} Edition’ The Laser Society of Japan, Applied Laser Technology, The Institute of Electronics and Communication Engineers, etc.

Moreover, as plate producing equipment comprising a fiber-coupled semiconductor laser that can be used suitably in the process for producing a relief printing plate employing the relief printing plate precursor of the present invention, those described in detail in JP-A-2009-172658 and JP-A-2009-214334 can be cited. Such equipment comprising a fiber-coupled semiconductor laser can be used to produce a relief printing plate of the present invention.

The process for producing a relief printing plate of the present invention may as necessary further comprise, subsequent to the engraving step, a rinsing step, a drying step, and/or a post-crosslinking step, which are shown below.

Rinsing step: a step of rinsing the engraved surface by rinsing the engraved relief layer surface with water or a liquid comprising water as a main component.

Drying step: a step of drying the engraved relief layer.

Post-crosslinking step: a step of further crosslinking the relief layer by applying energy to the engraved relief layer.

After the above-mentioned step, since engraving residue is attached to the engraved surface, a rinsing step of washing off engraving residue by rinsing the engraved surface with water or a liquid comprising water as a main component may be added. Examples of rinsing means include a method in which washing is carried out with tap water, a method in which high pressure water is spray-jetted, and a method in which the engraved surface is brushed in the presence of mainly water using a batch or conveyor brush type washout machine known as a photosensitive resin letterpress plate processor, and when slime due to engraving residue cannot be eliminated, a rinsing liquid to which a soap or a surfactant is added may be used.

When the rinsing step of rinsing the engraved surface is carried out, it is preferable to add a drying step of drying an engraved relief-forming layer so as to evaporate rinsing liquid.

Furthermore, as necessary, a post-crosslinking step for further crosslinking the relief-forming layer may be added. By carrying out a post-crosslinking step, which is an additional crosslinking step, it is possible to further strengthen the relief formed by engraving.

The pH of the rinsing liquid that can be used in the present invention is preferably at least 9, more preferably at least 10, and yet more preferably at least 11. The pH of the rinsing liquid is preferably no greater than 14, more preferably no greater than 13.5, and yet more preferably no greater than 13.1. When in the above-mentioned range, handling is easy.

In order to set the pH of the rinsing liquid in the above-mentioned range, the pH may be adjusted using an acid and/or a base as appropriate, and the acid or base used is not particularly limited.

The rinsing liquid that can be used in the present invention preferably comprises water as a main component.

The rinsing liquid may contain as a solvent other than water a water-miscible solvent such as an alcohol, acetone, or tetrahydrofuran.

The rinsing liquid preferably may comprise a surfactant.

From the viewpoint of removability of engraving residue and little influence on a relief printing plate, preferred examples of the surfactant that can be used in the present invention include betaine compounds (amphoteric surfactants) such as a carboxybetaine compound, a sulfobetaine compound, a phosphobetaine compound, an amine oxide compound, and a phosphine oxide compound.

Furthermore, examples of the surfactant also include known anionic surfactants, cationic surfactants, and nonionic surfactants. Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 wt % relative to the total weight of the rinsing liquid, and more preferably 0.05 to 10 wt %.

The relief printing plate of the present invention having a relief layer may be produced as described above.

From the viewpoint of satisfying suitability for various aspects of flexographic printing, such as abrasion resistance and ink transfer properties, the thickness of the relief layer of the relief printing plate is preferably at least 0.05 mm but no greater than 7 mm, more preferably at least 0.05 mm but no greater than 3 mm, and yet more preferably at least 0.05 mm but no greater than 1.5 mm.

Furthermore, the Shore A hardness of the relief layer of the relief printing plate is preferably at least 50° but no greater than 90°. When the Shore A hardness of the relief layer is at least 50°, even if fine halftone dots formed by engraving receive a strong printing pressure from a letterpress printer, they do not collapse and close up, and normal printing can be carried out. Furthermore, when the Shore A hardness of the relief layer is no greater than 90°, even for flexographic printing with kiss touch printing pressure it is possible to prevent patchy printing in a solid printed part.

The Shore A hardness in the present specification is a value measured by a durometer (a spring type rubber hardness meter) that presses an indenter (called a pressing needle or indenter) into the surface of a measurement target at 25° C. so as to deform it, measures the amount of deformation (indentation depth), and converts it into a numerical value.

The relief printing plate of the present invention is particularly suitable for printing with an aqueous ink by a flexographic printing machine; however, the relief printing plate is capable of printing even when any of an aqueous ink, an oil-based ink and a UV ink is used with a letterpress printing machine, and printing with a UV ink by a flexographic printing machine is also possible. The relief printing plate of the present invention has no or less bending (curling) in the printing plate as a whole, has excellent rinsing properties, has no remaining engraving residue, has no stickiness of the printing plate, and has excellent print durability.

According to the present invention, a relief printing plate precursor which is capable of suppressing curling and delamination in the relief-forming layer, a relief printing plate using the relief printing plate precursor for laser engraving, and a process for making the plate can be provided.

### EXAMPLES

Hereinafter, the present invention will be more specifically described by way of Examples, but the present invention is not intended to be limited to these Examples.

Furthermore, unless particularly stated otherwise, the weight average molecular weight (Mw) of the polymer in the Examples is indicated as the value measured by gel permeation chromatography (GPC). Furthermore, the unit “parts” as used in the Examples represents “parts by weight,” unless particularly stated otherwise.

### Production Example 1

### Preparation of Resin (d-1)

In a separable flask equipped with a thermometer, a stirrer and a reflux tube, 413.72 parts of “KF-6003” (number average molecular weight: 5,100, OH value: 22.0), which is a both terminal-carbinol-modified reactive silicone oil, and 11.05 parts of tolylene diisocyanate were introduced, and the mixture was allowed to react for about 6 hours at a temperature of 80° C. Subsequently, 4.99 parts of 2-methacryloyloxy isocyanate was added to the mixture, and the mixture was further allowed to react for about 3 hours. Thus, a resin having methacryl groups at both ends was prepared. The weight average molecular weight of resin (d-1) was 90,000. This resin was syrup-like at 20° C., and flowed when an external force was applied. Meanwhile, even if the external force was removed, the resin did not restore the original shape.

### Production Example 2

### Preparation of Resin (d-2)

In a separable flask equipped with a thermometer, a stirrer and a reflux tube, 1318 parts of “PCDL T4672” (number average molecular weight: 2,059, and OH value: 54.5), which is a polycarbonate diol, and 76.8 parts of tolylene diisocyanate were introduced, and the mixture was allowed to react for about 6 hours at a temperature of 80° C. Subsequently, 47.8 parts of 2-methacryloyloxy isocyanate was added to the mixture, and the mixture was further allowed to react for about 3 hours. Thus, a resin having methacryl groups at both ends was prepared. The weight average molecular weight of resin (d-2) was 100,000. This resin was syrup-like at 20° C., and flowed when an external force was applied. Meanwhile, even if the external force was removed, the resin did not restore the original shape.

### Example 1

### 1. Preparation of Composition for Laser Engraving

In a three-necked flask equipped with a stirring blade and a cooling tube, 40 parts of (A-1) shown below (molecular weight: 338.4) and 25 parts of BLENMER PME-200 (manufactured by NOF Corp., methoxypolyethylene glycol monomethacrylate, molecular weight: about 276) as Component A, and 50 parts of propylene glycol monomethyl ether acetate as a solvent were introduced. Furthermore, 5 parts of PBZ (t-butyl peroxybenzoate, manufactured by NOF Corp., trade name: “PERBUTYL Z”) as Component B, 10 parts of (C-1) (corresponding to the formula (I)) as Component C, 10 parts of (E-1) trade name “SYLOSPHERE C-1504” manufactured by Fuji Sylysia Chemical, Ltd. (porous spherical silica, number average particle size: 4.5 μm, specific surface area: 520 m²/g, average pore size: 12 nm, pore volume: 1.5 ml/g, ignition loss: 2.5 wt %, amount of oil absorption: 290 ml/100 g, the sphericity as observed by scanning electron microscopy was 0.9 or higher in almost all of the particles) as Component E, and 10 parts of (F-1) Ketjenblack EC600JD (carbon black, manufactured by Lion Corp.) as Component F were added to the mixture, and the resulting mixture was stirred for 30 minutes at 50° C. Through the operation described above, a coating liquid 1 for crosslinkable relief-forming layer (composition for laser engraving 1) having fluidity was obtained.

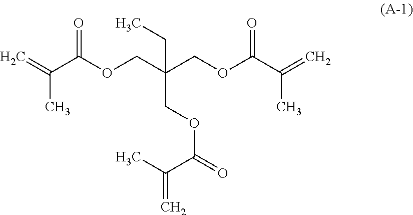 [SMILES: C=C(C)C(=O)OCC(CC)(COC(=O)C(=C)C)COC(=O)C(=C)C]

### 2. Production of Relief Printing Plate Precursor for Laser Engraving

A spacer (frame) having a predetermined thickness was provided on a PET substrate, and the coating liquid 1 for crosslinkable relief-forming layer obtained as described above was gently flow cast thereon to the extent that the coating liquid would not overflow over the spacer (frame). The coating liquid was dried and crosslinked for 2 hours in an oven at 100° C., and thereby a crosslinked relief-forming layer having a thickness of approximately 1 mm was provided. Thus, a relief printing plate precursor for laser engraving 1 was produced.

### 3. Production of Relief Printing Plate

The relief printing plate precursor for laser engraving 1 obtained as described above was engraved by using two kinds of lasers described below.

Engraving by laser irradiation was carried out by using a high resolution CO₂ laser marker ML-9100 series (manufactured by Keyence Corp.) as a carbon dioxide laser engraving machine. A protective film was detached from the printing plate precursor for laser engraving 1, and then a solid area which measured 1 cm on each of four sides was raster-engraved by using the carbon dioxide laser engraving machine, under the conditions of output power: 12 W, head sped: 200 mm/sec, and pitch setup: 2,400 DPI, to thereby form halftone dots with a highlight percentage of 1% to 10%.

As a semiconductor laser engraving machine, a laser recording apparatus equipped with a fiber-coupled semiconductor laser (FC-LD) SDL-6390 (manufactured by JDSU, wavelength: 915 nm) having a maximum output power of 8.0 W was used. A solid area which measured 1 cm on each of four sides was raster-engraved by using the semiconductor laser engraving machine, under the conditions of laser output power: 7.5 W, head sped: 409 mm/sec, and pitch setup: 2,400 DPI, to thereby form halftone dots with a highlight percentage of 1% to 10%.

The thickness of the relief layer of the relief printing plate was 1.05 mm. Furthermore, the Shore A hardness of the relief layer was measured by the measurement method described above, and the Shore A hardness was 50°. Meanwhile, the measurement of the Shore A hardness was carried out in the same manner in the Examples and Comparative Examples that will be described below.

### Example 2

### 1. Preparation of Composition for Laser Engraving

In a three-necked flask equipped with a stirring blade and a cooling tube, 20 parts of (A-1) shown below and 20 parts of BLENMER PME-200 (manufactured by NOF Corp.) as Component A, and 50 parts of propylene glycol monomethyl ether acetate as a solvent were introduced. Furthermore, 2 parts of PBZ (t-butyl peroxybenzoate, manufactured by NOF Corp., trade name: “PERBUTYL Z”) as Component B, 10 parts of (C-1) (corresponding to the formula (I)) as Component C, 30 parts of (d-1) as (Component D) binder polymer, 10 parts of (E-1) trade name “SYLOSPHERE C-1504” manufactured by Fuji Sylysia Chemical, Ltd. (porous spherical silica, number average particle size: 4.5 μm, specific surface area: 520 m²/g, average pore size: 12 nm, pore volume: 1.5 ml/g, ignition loss: 2.5 wt %, amount of oil absorption: 290 ml/100 g, the sphericity as observed by scanning electron microscopy was 0.9 or higher in almost all of the particles) as Component E, and 8 parts of (F-1) Ketjenblack EC600JD (carbon black, manufactured by Lion Corp.) as Component F were added to the mixture, and the resulting mixture was stirred for 3 hours at 50° C. Through the operation described above, a coating liquid 2 for crosslinkable relief-forming layer (composition for laser engraving 2) having fluidity was obtained.

The processes for 2. Production of relief printing plate precursor for laser engraving and 3. Production of relief printing plate were carried out in the same manner as in Example 1.

The thickness of the relief layer of the relief printing plate was 1.02 mm. Furthermore, the Shore A hardness of the relief layer was 70°.

### Examples 3 to 7

### 1. Preparation of Composition for Laser Engraving

Coating liquids 3 to 7 for crosslinkable relief-forming layer having fluidity (compositions for laser engraving 3 to 7) were obtained in the same manner as in Example 2, except that the compounds indicated in Table 1 were used as Component C.

The processes for 2. Production of relief printing plate precursor for laser engraving and 3. Production of relief printing plate were carried out in the same manner as in Example 1. The thickness of the relief layer of the relief printing plate and the shore A hardness of the relief layer had the values described below.

TABLE 1

| | |
|---|---|
| 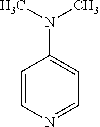 | (C-1) |
| 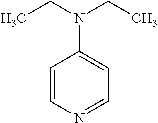 | (C-2) |
| 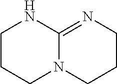 | (C-3) |
| 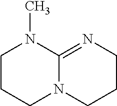 | (C-4) |
| 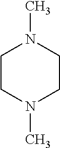 | (C-5) |
| 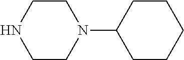 [SMILES: C1CCC(N2CCNCC2)CC1] | (C-6) |

| | Component C | Thickness (mm) | Shore A hardness (°) |
|---|---|---|---|
| Example 3 | C-2 | 1.00 | 72 |
| Example 4 | C-3 | 1.01 | 63 |
| Example 5 | C-4 | 1.00 | 65 |
| Example 6 | C-5 | 0.98 | 55 |
| Example 7 | C-6 | 1.00 | 57 |

Meanwhile, in regard to (C-1) to (C-6) described above, (C-2) corresponds to the formula (I) described above, (C-3) and (C-4) correspond to the formula (III) described above, and (C-5) and (C-6) correspond to the formula (II) described above.

### Example 8

### 1. Preparation of Composition for Laser Engraving

A coating liquid 8 for crosslinkable relief-forming layer having fluidity (composition for laser engraving 8) was obtained in the same manner as in Example 2, except that (d-2) was used as Component D.

The processes for 2. Production of relief printing plate precursor for laser engraving and 3. Production of relief printing plate were carried out in the same manner as in Example 1. The thickness of the relief layer of the relief printing plate was 1.02 mm. Furthermore, the Shore A hardness of the relief layer was 75°.

### Example 9

### 1. Preparation of Composition for Laser Engraving

A coating liquid 9 for crosslinkable relief-forming layer having fluidity (composition for laser engraving 9) was obtained in the same manner as in Example 2, except that (d-3) was used as Component D.

The processes for 2. Production of relief printing plate precursor for laser engraving and 3. Production of relief printing plate were carried out in the same manner as in Example 1. The thickness of the relief layer of the relief printing plate was 1.01 mm. Furthermore, the Shore A hardness of the relief layer was 62°.

(d-3): Tolylene diisocyanate/polypropylene glycol (average molecular weight: 2000)=50/50 (mol %), Mw=90,000)

### Example 10

### 1. Preparation of Composition for Laser Engraving

A coating liquid 10 for crosslinkable relief-forming layer having fluidity (composition for laser engraving 10) was obtained in the same manner as in Example 2, except that (d-4) was used as Component D.

The processes for 2. Production of relief printing plate precursor for laser engraving and 3. Production of relief printing plate were carried out in the same manner as in Example 1. The thickness of the relief layer of the relief printing plate was 1.05 mm. Furthermore, the Shore A hardness of the relief layer was 64°.

(d-4): DENKA BUTYRAL #3000-2 (manufactured by Denki Kagaku Kogyo K.K., polyvinyl butyral derivative, Mw=90,000)

### Example 11

### 1. Preparation of Composition for Laser Engraving

A coating liquid 11 for crosslinkable relief-forming layer having fluidity (composition for laser engraving 11) was obtained in the same manner as in Example 2, except that 20 parts of (A-2) shown below (Mw: 320.42) and 20 parts of BLENMER PME-200 (manufactured by NOF Corp.) was used as Component A.

The processes for 2. Production of relief printing plate precursor for laser engraving and 3. Production of relief printing plate were carried out in the same manner as in Example 1.

The thickness of the relief layer of the relief printing plate was 1.03 mm. Furthermore, the Shore A hardness of the relief layer was 74°.

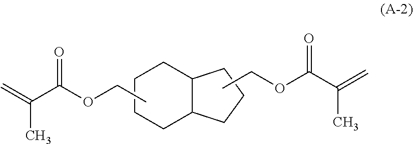

### Example 12

### 1. Preparation of Composition for Laser Engraving

A coating liquid 12 for crosslinkable relief-forming layer having fluidity (composition for laser engraving 12) was obtained in the same manner as in Example 2, except that 20 parts of (A-3) shown below (Mw: 228.24) and 20 parts of BLENMER PME-200 (manufactured by NOF Corp.) was used as Component A.

The processes for 2. Production of relief printing plate precursor for laser engraving and 3. Production of relief printing plate were carried out in the same manner as in Example 1.

The thickness of the relief layer of the relief printing plate was 1.03 mm. Furthermore, the Shore A hardness of the relief layer was 67°.

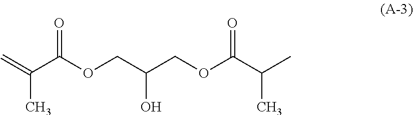 [SMILES: C=C(C)C(=O)OCC(O)COC(=O)C(C)C]

### Example 13

### 1. Preparation of Composition for Laser Engraving

A coating liquid 13 for crosslinkable relief-forming layer having fluidity (composition for laser engraving 13) was obtained in the same manner as in Example 2, except that 20 parts of (A-1) and 20 parts of BLENMER PME-100 (manufactured by NOF Corp., methoxypolyethyleneglycol monomethacylate, Mw: about 188) was used as Component A.

The processes for 2. Production of relief printing plate precursor for laser engraving and 3. Production of relief printing plate were carried out in the same manner as in Example 1.

The thickness of the relief layer of the relief printing plate was 1.03 mm. Furthermore, the Shore A hardness of the relief layer was 71°.

### Example 14

### 1. Preparation of Composition for Laser Engraving

A coating liquid 14 for crosslinkable relief-forming layer having fluidity (composition for laser engraving 14) was obtained in the same manner as in Example 2, except that 20 parts of (A-1) and 20 parts of BLENMER PME-400 (manufactured by NOF Corp., methoxypolyethyleneglycol monomethacylate, Mw: about 548) was used as Component A.

The processes for 2. Production of relief printing plate precursor for laser engraving and 3. Production of relief printing plate were carried out in the same manner as in Example 1.

The thickness of the relief layer of the relief printing plate was 1.05 mm. Furthermore, the Shore A hardness of the relief layer was 72°.

### Example 15

### 1. Preparation of Composition for Laser Engraving

A coating liquid 15 for crosslinkable relief-forming layer having fluidity (composition for laser engraving 15) was obtained in the same manner as in Example 2, except that 0.36 parts of (C-1) was used as Component C.

The processes for 2. Production of relief printing plate precursor for laser engraving and 3. Production of relief printing plate were carried out in the same manner as in Example 1.

The thickness of the relief layer of the relief printing plate was 1.04 mm. Furthermore, the Shore A hardness of the relief layer was 67°.

### Example 16

### 1. Preparation of Composition for Laser Engraving

A coating liquid 16 for crosslinkable relief-forming layer having fluidity (composition for laser engraving 16) was obtained in the same manner as in Example 2, except that 0.82 parts of (C-1) was used as Component C.

The processes for 2. Production of relief printing plate precursor for laser engraving and 3. Production of relief printing plate were carried out in the same manner as in Example 1.

The thickness of the relief layer of the relief printing plate was 1.06 mm. Furthermore, the Shore A hardness of the relief layer was 70°.

### Example 17

### 1. Preparation of Composition for Laser Engraving

A coating liquid 17 for crosslinkable relief-forming layer having fluidity (composition for laser engraving 17) was obtained in the same manner as in Example 2, except that 2.8 parts of (C-1) was used as Component C.

The processes for 2. Production of relief printing plate precursor for laser engraving and 3. Production of relief printing plate were carried out in the same manner as in Example 1.

The thickness of the relief layer of the relief printing plate was 1.08 mm. Furthermore, the Shore A hardness of the relief layer was 72°.

### Example 18

### 1. Preparation of Composition for Laser Engraving

A coating liquid 18 for crosslinkable relief-forming layer having fluidity (composition for laser engraving 18) was obtained in the same manner as in Example 2, except that 10 parts of (E-2) trade name “SYLYSIA 250” manufactured by Fuji Sylysia Chemical, Ltd. (porous spherical silica, number average particle size: 5.7 μm) was used as Component E.

The processes for 2. Production of relief printing plate precursor for laser engraving and 3. Production of relief printing plate were carried out in the same manner as in Example 1.

The thickness of the relief layer of the relief printing plate was 1.05 mm. Furthermore, the Shore A hardness of the relief layer was 70°.

### Example 19

### 1. Preparation of Composition for Laser Engraving

A coating liquid 19 for crosslinkable relief-forming layer having fluidity (composition for laser engraving 19) was obtained in the same manner as in Example 2, except that 10 parts of (E-3) trade name “Super Micro Bead Silica Gel 150A-10” manufactured by Fuji Sylysia Chemical, Ltd. (porous spherical silica, number average particle size: 10 μm) was used as Component E.

The processes for 2. Production of relief printing plate precursor for laser engraving and 3. Production of relief printing plate were carried out in the same manner as in Example 1.

The thickness of the relief layer of the relief printing plate was 1.07 mm. Furthermore, the Shore A hardness of the relief layer was 72°.

### Example 20

### 1. Preparation of Composition for Laser Engraving

A coating liquid 20 for crosslinkable relief-forming layer having fluidity (composition for laser engraving 20) was obtained in the same manner as in Example 2, except that (Component F) a photothermal conversion agent was not used.

The processes for 2. Production of relief printing plate precursor for laser engraving and 3. Production of relief printing plate were carried out in the same manner as in Example 1.

The thickness of the relief layer of the relief printing plate was 1.03 mm. Furthermore, the Shore A hardness of the relief layer was 67°.

### Example 21

### 1. Preparation of Composition for Laser Engraving

A coating liquid 21 for crosslinkable relief-forming layer having fluidity (composition for laser engraving 21) was obtained in the same manner as in Example 2, except that 10 parts of (A-1) and 10 parts of BLENMER PME-200 (manufactured by NOF Corp.) was used as Component A.

The processes for 2. Production of relief printing plate precursor for laser engraving and 3. Production of relief printing plate were carried out in the same manner as in Example 1.

The thickness of the relief layer of the relief printing plate was 1.02 mm. Furthermore, the Shore A hardness of the relief layer was 66°.

### Example 22

### 1. Preparation of Composition for Laser Engraving

A coating liquid 22 for crosslinkable relief-forming layer having fluidity (composition for laser engraving 22) was obtained in the same manner as in Example 2, except that 5 parts of (A-1) and 5 parts of BLENMER PME-200 (manufactured by NOF Corp.) was used as Component A.

The processes for 2. Production of relief printing plate precursor for laser engraving and 3. Production of relief printing plate were carried out in the same manner as in Example 1.

The thickness of the relief layer of the relief printing plate was 1.01 mm. Furthermore, the Shore A hardness of the relief layer was 60°.

### Comparative Example 1

### 1. Preparation of Composition for Laser Engraving

A coating liquid 23 for crosslinkable relief-forming layer having fluidity (composition for laser engraving 23) was obtained in the same manner as in Example 2, except that Component C was not added.

The processes for 2. Production of relief printing plate precursor for laser engraving and 3. Production of relief printing plate were carried out in the same manner as in Example 1. The thickness of the relief layer of the relief printing plate was 1.00 mm. Furthermore, the Shore A hardness of the relief layer was 42°.

### Comparative Example 2

### 1. Preparation of Composition for Laser Engraving

A coating liquid 24 for crosslinkable relief-forming layer having fluidity (composition for laser engraving 24) was obtained in the same manner as in Example 2, except that (CC-1) was used as Component C.

The processes for 2. Production of relief printing plate precursor for laser engraving and 3. Production of relief printing plate were carried out in the same manner as in Example 1. The thickness of the relief layer of the relief printing plate was 1.02 mm. Furthermore, the Shore A hardness of the relief layer was 50°.

### Comparative Example 3

### 1. Preparation of Composition for Laser Engraving

A coating liquid 25 for crosslinkable relief-forming layer having fluidity (composition for laser engraving 25) was obtained in the same manner as in Example 2, except that (CC-2) was used as Component C.

The processes for 2. Production of relief printing plate precursor for laser engraving and 3. Production of relief printing plate were carried out in the same manner as in Example 1. The thickness of the relief layer of the relief printing plate was 1.01 mm. Furthermore, the Shore A hardness of the relief layer was 49°.

### Comparative Example 4

### 1. Preparation of Composition for Laser Engraving

A coating liquid 26 for crosslinkable relief-forming layer having fluidity (composition for laser engraving 26) was obtained in the same manner as in Example 2, except that (CC-3) was used as Component C.

The processes for 2. Production of relief printing plate precursor for laser engraving and 3. Production of relief printing plate were carried out in the same manner as in Example 1. The thickness of the relief layer of the relief printing plate was 0.99 mm. Furthermore, the Shore A hardness of the relief layer was 43°.

### Comparative Example 5

### 1. Preparation of Composition for Laser Engraving

A coating liquid 27 for crosslinkable relief-forming layer having fluidity (composition for laser engraving 27) was obtained in the same manner as in Example 2, except that (CC-4) was used as Component C.

The processes for 2. Production of relief printing plate precursor for laser engraving and 3. Production of relief printing plate were carried out in the same manner as in Example 1. The thickness of the relief layer of the relief printing plate was 1.04 mm. Furthermore, the Shore A hardness of the relief layer was 38°.

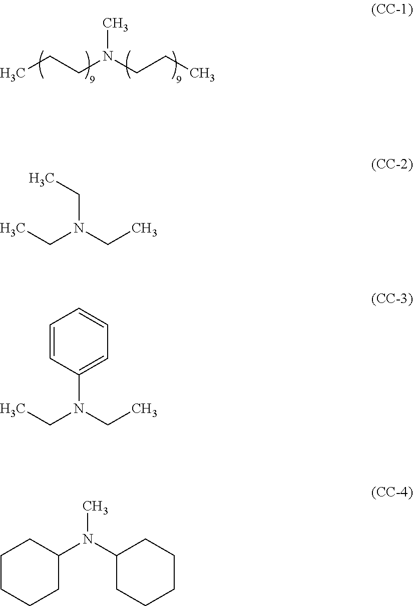

### Evaluation of Relief Printing Plate Precursors and Relief Printing Plates

A performance evaluation of the relief printing plates on the items described below was carried out, and the results are indicated in Table 2.

### (1) Engraving Depth

The “engraving depths” of the relief layers obtained by laser-engraving the relief-forming layers carried by the relief printing plates obtained in Examples 1 to 22 and Comparative Examples 1 to 5 were measured as follows. Here, the “engraving depth” means the difference between the engraved position (height) and the unengraved position (height), when the cross-section of the relief layer is observed. The “engraving depth” according to the present Examples was measured by observing the cross-section of the relief layer with an ultra-deep color 3D profile measuring microscope VK9510 (manufactured by Keyence Corp.). A larger engraving depth means higher engraving sensitivity. The results are described in Table 2 separately for the lasers used for engraving.

### (2) Rinsing Properties

A plate that had been laser-engraved by using a CO₂ laser was immersed in water, and the engraved area was rubbed 10 times with a toothbrush (manufactured by Lion Corp., CLINICA TOOTHBRUSH FLAT). Thereafter, the presence or absence of residue on the surface of the relief layer was checked with an optical microscope. A sample without any residue was rated as A; a sample with almost no residue was rated as B; a sample with a slight amount of residue was rated as C; and a sample with residue remaining thereon was rated as D.

### (3) Print Durability

A relief printing plate thus obtained was rinsed by the method described in the section (2) Evaluation of rinsing properties, and then the relief printing plate was mounted on a printing machine (Model ITM-4, manufactured by Iyo Kikai Seisakusho Co., Ltd.). Printing was continuously carried out by using an aqueous ink, AQUA SPZ16 Red (manufactured by Toyo Ink Group) as an ink, without diluting the ink, and using Full-color Form, M 70 (manufactured by Nippon Paper Group, thickness: 100 μm) as a printing paper. Thus, a highlight percentage of 1% to 10% was confirmed on the print material. The time point at which unprinted halftone dots were generated was defined as the termination of printing, and the length (meters) of printed paper until the termination of printing was used as an index. A larger value was evaluated to indicate superior print durability.

### (4) Tackiness

A relief printing plate precursor having a crosslinked relief-forming layer thus obtained was cut to a square which measured 2 cm×2 cm, and surface stickiness (tackiness) was evaluated on the basis of the amount of attachment of cellulose powder (manufactured by Nippon Paper Chemicals Co., Ltd.). The samples were evaluated based on a four-grade system such that a sample to which the cellulose powder did not attach was rated as A; a sample to which the cellulose powder attached was rated as D; and samples between the two grades were rated as B and C in an increasing order of the amount of attachment.

### (5) Curling

The degree of curling of a relief printing plate precursor having a crosslinked relief-forming layer thus obtained was evaluated by visual inspection. The samples were evaluated based on a four-grade system such that a sample that did not curl was rated as A; a sample that curled was rated as D; and samples between the two grades were rated as B and C in an increasing order of the degree of curling.

### (6) Peeling Resistance

The ease of peeling of the film (relief layer) of a relief printing plate was evaluated by the method described below. If the peeling resistance was high according to the evaluation, when an external force is applied to the relief printing plate, peeling at the support or the cushion layer does not occur, and the relief printing plate can be handled safely.

The peeling resistance was evaluated as the area of peeling obtained by a tape peeling test. That is, the coated surface (surface on the side of the crosslinked relief-forming layer) of a relief printing plate precursor after thermal crosslinking was subjected to a cross-cut tape peeling test according to JIS D0202-1988. A cellophane tape (“CT24”, manufactured by Nichiban Co., Ltd.) was used to attach the tape on the coated surface with a finger, and then the tape was peeled off.

The determination was made as follows: based on the ratio of peeled area (ratio of the peeled area with respect to the total area of the film), A: less than 5%, B: at least 5% but no greater than 10%, C: greater than 10% but no greater than 30%, and D: greater than 30%. The results are indicated in Table 2.

### (7) Delamination

The cross-section of a relief printing plate precursor having a crosslinked relief-forming layer thus obtained was observed, and the degree of delamination was evaluated by visual inspection. A sample in which delamination was not clearly observed by visual inspection was rated as A; and a sample in which delamination was clearly observed was rated as B.

TABLE 2

| | | | | | Wt % of | Wt % of | | | |
|---|---|---|---|---|---|---|---|---|---|
| | | | | | Component C | component C | | | |
| | | | | | relative to | relative to | | | |
| | Component A | | Component B | Component C | total amount | Component A | Component D | Component E | Component F |
| Ex. 1 | A-1 | PME-200 | PBZ | C-1 | 10 | 25 | — | E-1 | F-1 |
| Ex. 2 | A-1 | PME-200 | PBZ | C-1 | 10 | 25 | d-1 | E-1 | F-1 |
| Ex. 3 | A-1 | PME-200 | PBZ | C-2 | 10 | 25 | d-1 | E-1 | F-1 |
| Ex. 4 | A-1 | PME-200 | PBZ | C-3 | 10 | 25 | d-1 | E-1 | F-1 |
| Ex. 5 | A-1 | PME-200 | PBZ | C-4 | 10 | 25 | d-1 | E-1 | F-1 |
| Ex. 6 | A-1 | PME-200 | PBZ | C-5 | 10 | 25 | d-1 | E-1 | F-1 |
| Ex. 7 | A-1 | PME-200 | PBZ | C-6 | 10 | 25 | d-1 | E-1 | F-1 |
| Ex. 8 | A-1 | PME-200 | PBZ | C-1 | 10 | 25 | d-2 | E-1 | F-1 |
| Ex. 9 | A-1 | PME-200 | PBZ | C-1 | 10 | 25 | d-3 | E-1 | F-1 |
| Ex. 10 | A-1 | PME-200 | PBZ | C-1 | 10 | 25 | d-4 | E-1 | F-1 |
| Ex. 11 | A-2 | PME-200 | PBZ | C-1 | 10 | 25 | d-1 | E-1 | F-1 |
| Ex. 12 | A-3 | PME-200 | PBZ | C-1 | 10 | 25 | d-1 | E-1 | F-1 |
| Ex. 13 | A-1 | PME-100 | PBZ | C-1 | 10 | 25 | d-1 | E-1 | F-1 |
| Ex. 14 | A-1 | PME-400 | PBZ | C-1 | 10 | 25 | d-1 | E-1 | F-1 |
| Ex. 15 | A-1 | PME-200 | PBZ | C-1 | 0.4 | 0.9 | d-1 | E-1 | F-1 |
| Ex. 16 | A-1 | PME-200 | PBZ | C-1 | 0.9 | 2.1 | d-1 | E-1 | F-1 |
| Ex. 17 | A-1 | PME-200 | PBZ | C-1 | 3 | 7 | d-1 | E-1 | F-1 |
| Ex. 18 | A-1 | PME-200 | PBZ | C-1 | 10 | 25 | d-1 | E-2 | F-1 |
| Ex. 19 | A-1 | PME-200 | PBZ | C-1 | 10 | 25 | d-1 | E-3 | F-1 |
| Ex. 20 | A-1 | PME-200 | PBZ | C-1 | 11.1 | 25 | d-1 | E-1 | — |
| Ex. 21 | A-1 | PME-200 | PBZ | C-1 | 12.5 | 50 | d-1 | E-1 | F-1 |
| Ex. 22 | A-1 | PME-200 | PBZ | C-1 | 14.3 | 100 | d-1 | E-1 | F-1 |
| Comp. Ex. 1 | A-1 | PME-200 | PBZ | — | 0 | 0 | d-1 | E-1 | F-1 |
| Comp. Ex. 2 | A-1 | PME-200 | PBZ | CC-1 | 10 | 25 | d-1 | E-1 | F-1 |
| Comp. Ex. 3 | A-1 | PME-200 | PBZ | CC-2 | 10 | 25 | d-1 | E-1 | F-1 |
| Comp. Ex. 4 | A-1 | PME-200 | PBZ | CC-3 | 10 | 25 | d-1 | E-1 | F-1 |
| Comp. Ex. 5 | A-1 | PME-200 | PBZ | CC-4 | 10 | 25 | d-1 | E-1 | F-1 |

| | Performance evaluation | | | | | | | |
|---|---|---|---|---|---|---|---|---|
| | Engraving | Engraving | | Print | | | | Delamination |
| | depth (μm) | depth (μm) | Rinsing | durability | | | Peeling | (visual |
| | FC-LD | CO₂ laser | properties | (m) | Tackiness | Curling | resistance | inspection) |
| Ex. 1 | 420 | 320 | B | 1,100 | C | B | B | A |
| Ex. 2 | 410 | 315 | A | 1,750 | A | A | A | A |
| Ex. 3 | 400 | 310 | A | 1,700 | A | A | A | A |
| Ex. 4 | 395 | 300 | B | 1,650 | B | B | B | A |
| Ex. 5 | 400 | 300 | B | 1,600 | B | B | B | A |
| Ex. 6 | 380 | 290 | C | 1,300 | C | C | C | A |
| Ex. 7 | 370 | 285 | C | 1,350 | C | C | C | A |
| Ex. 8 | 410 | 310 | A | 1,800 | A | A | A | A |
| Ex. 9 | 390 | 300 | A | 1,450 | B | A | B | A |
| Ex. 10 | 395 | 300 | A | 1,400 | B | A | B | A |
| Ex. 11 | 420 | 330 | A | 1,750 | A | A | A | A |
| Ex. 12 | 430 | 325 | A | 1,700 | A | A | A | A |
| Ex. 13 | 425 | 335 | A | 1,750 | A | A | A | A |
| Ex. 14 | 420 | 330 | A | 1,700 | A | A | A | A |
| Ex. 15 | 390 | 290 | A | 1,300 | C | C | C | A |
| Ex. 16 | 400 | 310 | A | 1,350 | B | B | B | A |
| Ex. 17 | 400 | 315 | A | 1,550 | A | B | B | A |
| Ex. 18 | 360 | 280 | B | 1,600 | A | A | A | A |
| Ex. 19 | 350 | 270 | C | 1,500 | A | A | A | A |
| Ex. 20 | 1 | 270 | B | 1,600 | B | A | A | A |
| Ex. 21 | 390 | 300 | A | 1,350 | B | B | B | A |
| Ex. 22 | 370 | 290 | A | 1,200 | B | B | B | A |
| Comp. Ex. 1 | 350 | 260 | D | 400 | D | D | D | B |
| Comp. Ex. 2 | 370 | 290 | D | 900 | D | D | D | B |
| Comp. Ex. 3 | 380 | 290 | D | 850 | D | D | D | B |
| Comp. Ex. 4 | 375 | 285 | D | 600 | D | D | D | B |
| Comp. Ex. 5 | 400 | 310 | D | 700 | D | D | D | B |

What is claimed is:

1. A relief printing plate precursor comprising, on a support, a relief-forming layer comprising:
(Component A) an ethylenically unsaturated compound;
(Component B) a thermal polymerization initiator; and
(Component C) an amine compound represented by any of formulae (I) to (III) below,
wherein the relief-forming layer having a thickness of 0.1 mm to 10 mm, 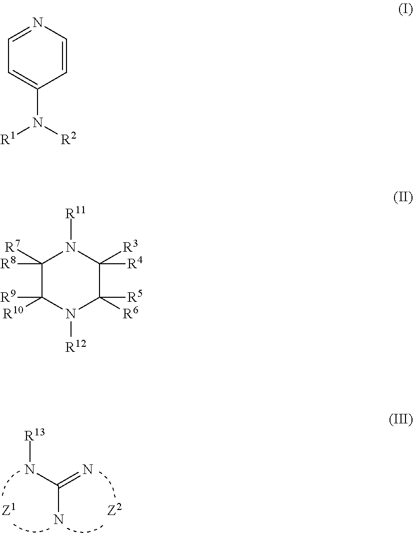
wherein in the formula (I), R¹ and R² independently represent a hydrogen atom, an alkyl group, a cycloalkyl group, an aralkyl group or an aryl group; in the formula (II), R³ to R¹⁰ independently represent a hydrogen atom, an alkyl group, a cycloalkyl group, an aralkyl group or an aryl group, while these groups may have a substituent, or may be linked to each other to form a ring; R¹¹ and R¹² independently represent a hydrogen atom, an alkyl group, a cycloalkyl group, an aralkyl group or an aryl group, while these groups may have a substituent; R³ to R¹⁰ and R¹¹ or R¹² may be linked to each other to form a ring; in the formula (III), R¹³ represents a hydrogen atom, an alkyl group, a cycloalkyl group, an aralkyl group, an aryl group or an acyl group, while these groups may have a substituent; and Z¹ and Z² independently represent an atomic group which forms a monocyclic or polycyclic ring structure together with an amino group, provided that Z¹ and Z² may be linked to each other to form a ring.

2. The relief printing plate precursor according to claim 1, wherein the content of Component C in the relief-forming layer is 1 wt % to 100 wt %, relative to 100 wt % of the content of Component A in the relief-forming layer.

3. The relief printing plate precursor according to claim 1, wherein Component B is an organic peroxide.

4. The relief printing plate precursor according to claim 1, wherein the relief-forming layer further comprises (Component D) a binder polymer.

5. The relief printing plate precursor according to claim 4, wherein Component D is one or more resins selected from the group consisting of a polycarbonate resin, a polyurethane resin, an acrylic resin, a polyester resin and a vinyl resin.

6. The relief printing plate precursor according to claim 1, wherein the relief-forming layer further comprises (Component E) silica particles.

7. The relief printing plate precursor according to claim 6, wherein the number average particle size of Component E is 0.01 μm to 10 μm.

8. The relief printing plate precursor according to claim 1, wherein the relief-forming layer further comprises (Component F) a photothermal conversion agent capable of absorbing light having a wavelength of 700 to 1,300 nm.

9. The relief printing plate precursor according to claim 1, wherein Component A comprises a monofunctional monomer and a polyfunctional monomer.

10. The relief printing plate precursor according to claim 1, wherein Component A comprises methoxypolyethylene glycol methacrylate.

11. The relief printing plate precursor according to claim 1, wherein Component C is an amine compound represented by formula (I) or formula (III).

12. The relief printing plate precursor according to claim 1, wherein Component C is an amine compound represented by formula (I).

13. The relief printing plate precursor according to claim 2, wherein Component B is an organic peroxide.

14. The relief printing plate precursor according to claim 2, wherein the relief-forming layer further comprises (Component D) a binder polymer.

15. The relief printing plate precursor according to claim 14, wherein Component D is one or more resins selected from the group consisting of a polycarbonate resin, a polyurethane resin, an acrylic resin, a polyester resin and a vinyl resin.

16. A relief printing plate precursor comprising a crosslinked relief-forming layer obtained by thermally crosslinking the relief-forming layer in the relief printing plate precursor for laser engraving according to claim 1.

17. The relief printing plate precursor according to claim 16, wherein the Shore A hardness of the crosslinked relief-forming layer is 50° to 90°.

18. A process for making a relief printing plate, the method comprising:
(1) preparing the relief printing plate precursor having a crosslinked relief-forming layer according to claim 16; and
(2) laser-engraving the crosslinked relief-forming layer and thereby forming a relief layer.

19. A relief printing plate comprising the relief layer produced by the process for making the plate according to claim 18.
